(19) United States
(12) Patent Application Publication
(10) Pub. No.: US 2024/0418738 A1
(43) Pub. Date: Dec. 19, 2024

(54) AUTOMATED PIPETTE TIP ORGANIZING FOR FLUID HANDLING SYSTEMS

(71) Applicant: Beckman Coulter, Inc., Brea, CA (US)

(72) Inventors: Mark F. SAUERBURGER, Zionsville, IN (US); Rachel Ellen MOSCHELL, Carmel, IN (US); Peter Robert NEI, Brownsburg, IN (US); John S. SNIDER, Brownsburg, IN (US); Matthew S. DAVIS, Indianapolis, IN (US); Peng WANG, Carmel, IN (US)

(73) Assignee: Beckman Coulter, Inc., Brea, CA (US)

(21) Appl. No.: 18/705,930

(22) PCT Filed: Nov. 7, 2022
(86) PCT No.: PCT/US2022/049165

§ 371 Date: Apr. 29, 2024

Related U.S. Application Data
(60) Provisional application No. 63/277,396, filed on Nov. 9, 2021.

(51) Int. Cl. G01N 35/10

(52) U.S. Cl. CPC G01N 35/1011; G01N 2035/1013; G01N 2035/103

(57) ABSTRACT

A method for automatically defragmenting pipette tips in a tip tray during the performance of a procedure defined by a protocol stored in memory of a fluid handling system, the method comprising determining locations of open receptacles in the tip tray where pipette tips are absent, determining locations of filled receptacles in the tip tray where pipette tips are present, and using the fluid handling system to move pipette tips from filled receptacles to open receptacles to complete strings of filled receptacles in the tip tray.

### CROSS-REFERENCE TO RELATED APPLICATIONS

This application claims the benefit of and priority to U.S. Provisional Patent Application No. 63/277,396, filed Nov. 9, 2021, the entire contents of which are incorporated herein by reference.

### TECHNICAL FIELD

The present application relates generally, but not by way of limitation, to fluid handling systems, such as those that can be used in various applications to combine reagents (e.g., liquid reagents and solvents) or other fluids. More particularly, the present application relates to systems and methods for arranging pipette tips loaded into a robotic fluid handling system, such as to improve access to the pipette tips by moving parts of the fluid handling system and to expedite performance of protocols and operations performed by the fluid handling system.

### BACKGROUND

Many fluid handling systems are configured to be loaded with containers of liquids for performing library constructions (e.g., libraries of DNA or RNA fragments for sequencing) using a plurality of reagents and solvents. To perform library construction on samples using a fluid handling system, such as a liquid handler, the fluid handling system is typically set-up by an operator or user. Set-up can include loading various items onto a deck of the fluid handling system including samples, library construction reagents, and various items of labware, such as pipette tips, plate lids, and liquid containers of various types and configurations, including reservoirs, microtiter plates, test tubes, vials, microfuge tubes, and the like, according to a protocol programmed into the fluid handling system for performing the library construction.

Pipette tips can be provided by the manufacturer or arranged by a user in boxes, trays or racks. Typical arrangements comprise a rectangular array of rows and columns of pipette tips loaded into individual sockets or receptacles in a rack. The pipette tips can be spaced appropriately to allow each of the multiple mandrels of a multichannel pipetting tool of the fluid handling system access to a pipette tip. Each mandrel of a single or multichannel pipetting tool can be loaded with a clean pipette tip from the rack before using the pipetting tool in a pipetting operation. Used pipette tips can then be dropped into a refuse container before the pipetting tool is moved back to the rack to obtain a fresh, unused pipette tip. Fresh pipette tips can be removed from the rack in various numbers and from disparate locations to execute different pipetting operations using different pipetting tools. Thus, after a fluid handling system performs a complete protocol, the rack of pipette tips can be partially used leaving unused pipette tips in random locations throughout the rack. Use of the unused pipette tips for a subsequent operation typically requires a user to manually reload the box or tray with sufficient pipette tips to perform the next operation. Such tasks can be labor intensive, time consuming, and can lead to contamination of the unused pipette tips due to their manual handling.

### Overview

The present inventors have recognized, among other things, that problems to be solved in preparing fluid handling systems for performing protocols involving pipetting operations include the need for direct operator interaction required to, either at the beginning or end of a protocol, check the fluid handling system for partial pipette-tip containers, e.g., racks, boxes and trays, and reload the containers to capacity. Frequently, one partially-filled pipette tip container is used to repopulate another partially-filled pipette tip container.

The present subject matter can provide solutions to these problems and other problems, such as by providing a fluid handling system that can automatically perform pipette-tip-container defragmentation and reformatting procedures to reduce or eliminate empty pipette tip locations within the container or to strategically produce strings of pipette tips that facilitate performance of protocols or improve access to pipette tips. In various examples, the defragmenting and reformatting operations can be run before, during or after a protocol. In various examples, the defragmenting and reformatting operations can include tracking and mapping in real time the consumption of pipette tips so that unused pipette tips can be loaded into empty locations. In various examples, the defragmenting and reformatting operations can utilize imaging to identify empty locations in need of being refilled with an unused pipette tip. In various examples, the defragmenting and reformatting operations can sense the presence of locations in the pipette tip container where pipette tips are located to determine locations where unused pipette tips are needed to be reloaded.

In an example, a method for automatically defragmenting pipette tips in a tip tray during the performance of a procedure defined by a protocol stored in memory of a fluid handling system can comprise determining locations of open receptacles in the tip tray where pipette tips are absent, determining locations of filled receptacles in the tip tray where pipette tips are present, and using the fluid handling system to move pipette tips from filled receptacles to open receptacles to complete strings of filled receptacles in the tip tray.

In an example, a method for automatically defragmenting pipette tips in a tip tray during the performance of a procedure defined by a protocol stored in memory of a fluid handling system can comprise determining locations of open receptacles in the tip tray where pipette tips are absent, determining locations of filled receptacles in the tip tray where pipette tips are present, and using the fluid handling system to move pipette tips from filled receptacles to open receptacles to producing patterns of filled receptacles in rows of the tip tray according to usage of tips as defined in the protocol.

In another example, a method for automatically defragmenting pipette tips in a first tip tray during the performance of a procedure defined by a protocol stored in memory of a fluid handling system can comprise determining locations of open receptacles in the first tip tray where pipette tips are absent, determining locations of filled receptacles in the first tip tray where pipette tips are present, and using the fluid handling system to move pipette tips from filled receptacles of a second tip tray to open receptacles to complete strings of filled receptacles in the first tip tray.

### BRIEF DESCRIPTION OF THE DRAWINGS

FIG. 1 is a block diagram of a robotic fluid handling system according to an example of the present disclosure.

FIG. 2 is perspective view of an exemplary robotic fluid handling system of FIG. 1 comprising a housing, a carousel, a reaction vessel, a thermal cycler module and an imaging device located with respect to a deck.

FIG. 3 a schematic diagram illustrating an item of labware, a labware receptacle, a transport device and an imaging device positioned relative to a deck, further illustrated in FIGS. 4 and 5.

FIG. 4 is a plan view of the deck of FIG. 3 for loading into the housing of FIG. 2 with various items of labware, including reaction vessels, a carousel and a thermal cycler reaction vessel holder, positioned on the deck.

FIG. 5 is a plan view of the deck of FIG. 4 without the items of labware loaded thereon to show a bulk reaction vessel holder, a labware holder for reaction vessels, a labware holder for pipette tip containers or microplates and a thermal cycler reaction vessel holder.

FIG. 6 is a perspective view of a manifold that can be coupled to a transport device of a fluid handling system of the present disclosure.

FIG. 7 is a cross-sectional view of the manifold of FIG. 6 taken at section 7-7 showing a circuit board, a mandrel, a pipette tip, a plunger and a connector pin.

FIG. 8 is a perspective view of a pipette tip rack at full capacity of unused pipette tips.

FIGS. 9A-9E illustrate schematic maps of the pipette tip rack of FIG. 8 showing examples of defragmenting after running a protocol.

FIGS. 10A-10F illustrate schematic maps of the pipette tip rack of FIG. 8 showing examples of defragmenting during running of a protocol.

FIG. 11A-11C illustrate schematic maps of the pipette tip rack of FIG. 8 showing examples of defragmenting before running of a protocol.

FIGS. 12A and 12B illustrate a line diagram showing steps for automatically performing pipette tip defragmentation or reformatting on the pipette tip rack of FIGS. 8-11C using a robotic fluid handling system of FIGS. 1-7.

FIG. 13A is side view of the deck of FIG. 4 taken along the Y-direction to show locations for tip racks arranged in a stadium configuration to facilitate access by a manifold.

FIG. 13B is a side view of the deck of FIG. 4 taken along the X-direction to show locations for tip racks arranged in tiers of the stadium configuration to facilitate access by a manifold.

### DETAILED DESCRIPTION

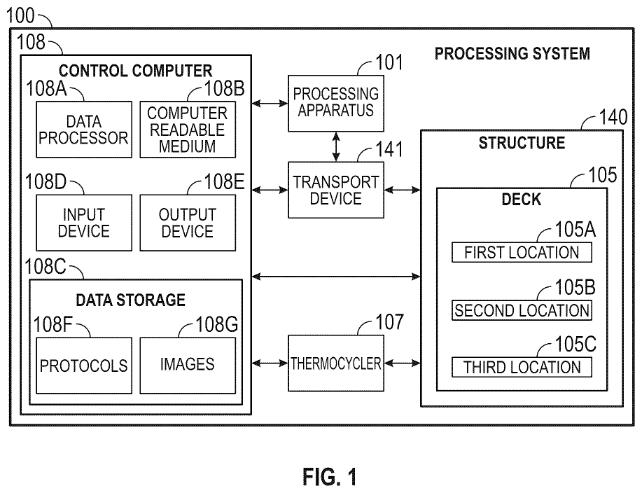

FIG. 1 is a high-level block diagram of processing system 100 according to an example of the disclosure. Processing system 100 can comprise a liquid or fluid handling system with which pipette tip defragmentation or reformatting procedures of the present disclosure can be executed. Processing system 100 can comprise control computer 108 operatively coupled to structure 140, transport device 141, processing apparatus 101 and thermal cycler system 107. Input/output interfaces can be present in each of these devices to allow for data transmission between the illustrated devices and external devices. Processing system 100 can comprise a robotic fluid handling system as described herein. Fluids can include various liquids such as reagents and the like. Exemplary processing systems in which the present disclosure can be implemented are the Biomek i7 Automated Workstation, and the Biomek NGeniuS Automated Workstation, each of which are marketed by Beckman Coulter, Inc. of Brea, California.

For explanatory purposes, processing system 100 will mainly be described as a system for processing and analyzing biological samples, such as the preparation of libraries of nucleic acid fragments (e.g., libraries of fragments derived from DNA or RNA molecules) including next-generation sequencing (NGS) libraries. For example, examples of the present disclosure can include thermocycling and incubating reagents in a reaction vessel loaded into a thermocycling system, wherein the single reaction vessel and the single thermocycling system can perform a plurality of different heating functions for different liquids loaded therein. Processing system 100 can additionally be representative of other types of fluid handling systems.

In order to properly process reagents and specimen within the systems processing modules (e.g., a reaction vessel), and provide other functionality of a fluid handling system, liquids can be moved around and combined within the fluid handling system using pipette tips attached to a pipetting tool or manifold via mandrels. Typically, the pipette tips are disposable and configured to be used one time to avoid contamination. As such, the pipetting tool or manifold is repeatedly self-loading clean, unused pipette tips from storage containers within the fluid handling system, performing a pipetting operation, discarding the dirty, used pipette tip into a refuse container, and reloading a new pipette tip. The present disclosure describes systems and methods for monitoring consumption of pipette tips from a pipette tip container, obtaining unused pipette tips from other containers, and rearranging unused pipette tips in the container to organize the unused pipette tips in arrangements that can facilitate rapid performance of the current protocol and hasten performance of a subsequent protocol. Thus, processing system 100 can be used to verify the locations of pipette tips, monitor the consumption of pipette tips, and keep track of the locations of open pipette-tip receptacles and filled pipette-tip receptacles so that unused pipette tips can be added to and organized within a pipette-tip container to facilitate subsequent operations and protocols. Partially-used pipette-tip containers can be reformatted or defragmented. Reformatting can include completely refilling a pipette-tip container to capacity or arranging the container to include patterns of pipette tips to facilitate performance of various pipetting operations in a protocol. Defragmenting can include arranging blocks or strings of consecutive pipette tips to eliminate or reduce empty spaces.

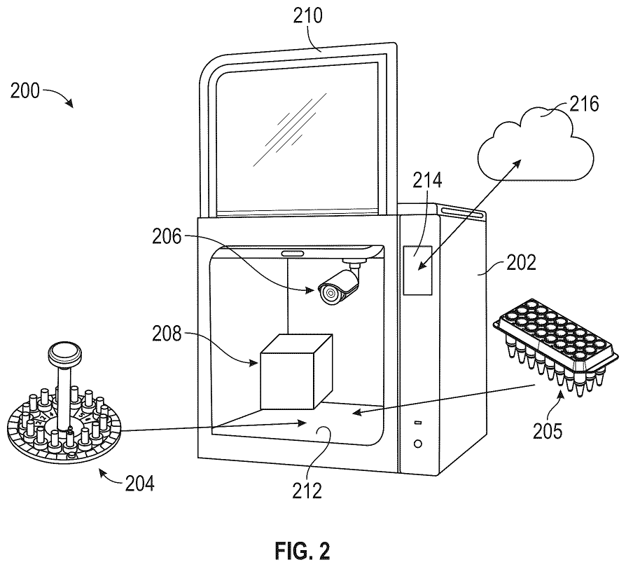

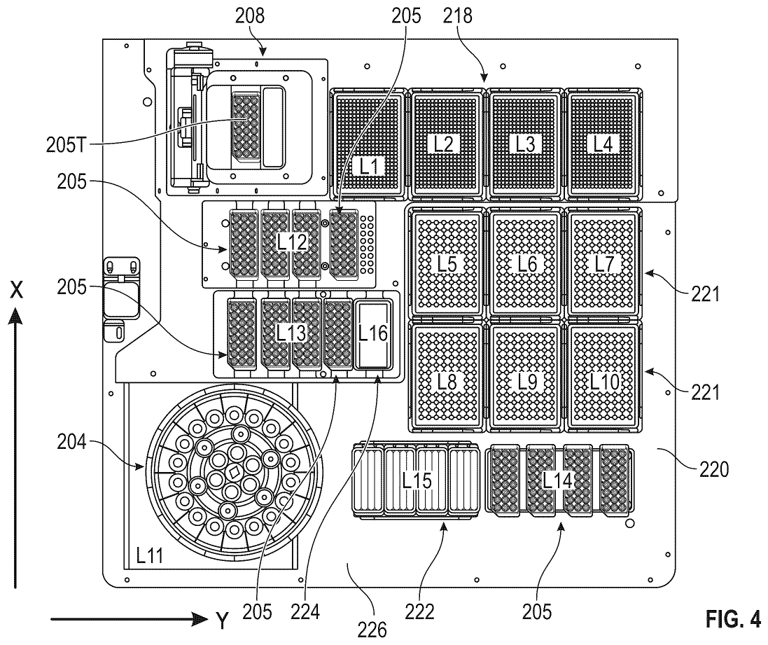

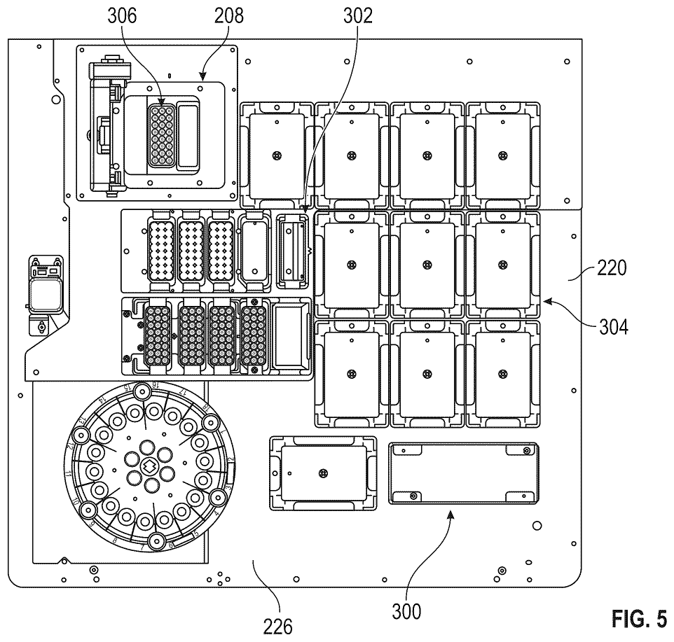

Structure 140 can include a housing (e.g., housing 202 of FIG. 2), legs or casters to support the housing, power source, deck 105 loadable within the housing, and any other suitable feature. Deck 105 can hold permanently attached modules for the automated performance of a plurality of sample preparations or assays (processing apparatus 101) such as can be used in library constructions for next generation sequencing. Additionally, deck 105 can include a physical surface (e.g., platform 212 of FIG. 2) such as a planar physical surface upon which components can be reversibly placed and accessed for experiments, analyses, and processes. In some instances, deck 105 can be a floor or a tabletop surface. Deck 105 can be subdivided into a plurality of discrete deck locations (e.g., locations L1-L16 of FIG. 4) for placing different components. The locations can be directly adjacent or can be spaced apart from each other. Each deck location can include dividers, inserts, and/or any other support structure for separating the different deck locations and containing components, as shown in FIG. 5. For exemplary purposes, FIG. 1 shows first location 105A, second location 105B, and third location 105C on deck 105, though additional locations can be included. One or more of locations 105A-105C can be loaded with a carousel (e.g., carousel 204 of FIG. 2) or one or more microtiter plates or reaction vessels (e.g. reaction vessel 205 of FIG. 2) that can include spaces for holding one or more components, such as liquids or vials of liquid. With regard to the present application, deck 105 can include one or more locations for the placement of pipette tip boxes, racks or trays.

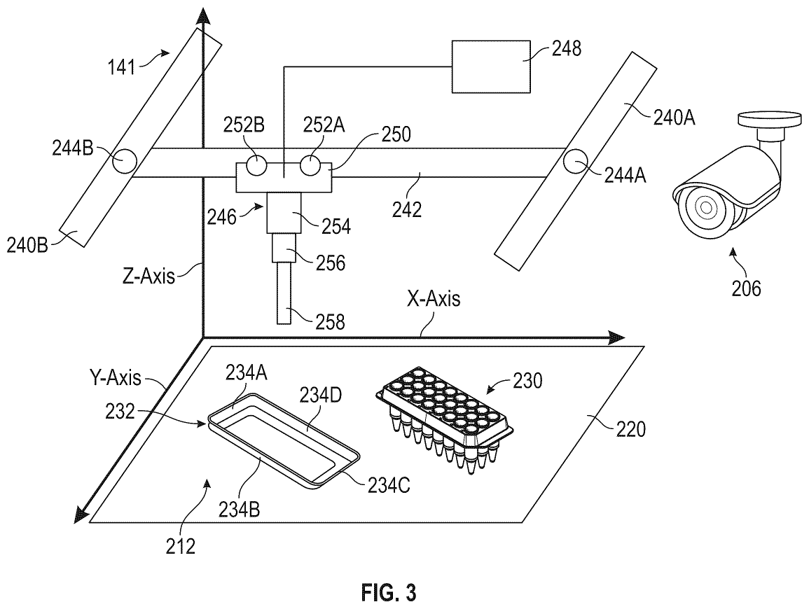

Transport device 141 can comprise a trolley, bridge or carriage system having moving capabilities in X and Y directions and hoisting capabilities in a Z direction (see FIG. 3). Transport device 141 can represent multiple transport devices, can prepare and/or transport components between deck 105 and processing apparatus 101, as well as between different locations on deck 105. Examples of transport devices can include conveyors, cranes, sample tracks, pick and place grippers, laboratory transport elements that can move independently (e.g., pucks, hubs or pedestals), robotic arms, and other tube or component conveying mechanisms. Transport device 141 can comprise a mandrel (e.g., tip mandrel 256 of FIG. 3). Mandrels can be fitted with working tools, as well as presence-sensing capabilities such as capacitance sensors. In some examples, the working tool mounted to transport device 141 comprises a fluid dispenser, such as a pipetting head configured to transfer liquids. The pipetting head can comprise a single-channel pipettor or a multichannel pipettor, configured to transfer liquids using pipette tips reversibly attached to pipette-tip mandrels of the pipettor. The multichannel pipettor can include a single displaceable piston configured to actuate each channel simultaneously via coupling to a manifold. Pipette tips can be attached to the pipetting head and can be disposed of after each use. Pipetting heads can also include grippers suitable for grasping or releasing other labware, such as microwell plates.

Processing apparatus 101 can include any number of machines or instruments for executing any suitable process. For example, processing apparatus 101 can include an analyzer, which can include any suitable instrument that is capable of analyzing a sample such as a biological sample. Examples of analyzers include spectrophotometers, luminometers, mass spectrometers, immunoanalyzers, hematology analyzers, microbiology analyzers, flow cytometers, and/or molecular biology analyzers. In some examples, processing apparatus 101 can include a sample staging apparatus. A sample staging apparatus can include a sample presentation unit for receiving sample tubes with biological samples, a sample storage unit for temporarily storing sample tubes or sample retention vessels, a means or device for aliquotting a sample, such as an aliquottor, a means for holding at least one reagent pack comprising the reagents needed for an analyzer, and any other suitable features. Processing apparatus 101 can further comprise a device for mixing the specimen and a shaker or stirrer for agitating or mixing liquids and reagents, etc.

Thermal cycler system 107 can be positioned relative to deck 105 and can be configured to receive a liquid vessel, such as reaction vessel 205 (FIG. 2). Liquid vessels can be loaded manually into thermal cycler system 107 or via transport device 141. Thermal cycler system 107 can be configured to provide a plurality of different heating zones that can heat different portions of reaction vessel 205 to different temperatures. Thus, for example, depending on the amount and type of liquid disposed in reaction vessel 205, different amounts of heating can be applied, such as to perform thermocycling and incubating processes.

Processing system 100 can be provided with an imaging system, e.g., a camera such as imaging device 206 (FIG. 2), to view the presence of items of labware loaded on deck 105, the presence of pipette tips loaded into tip trays, and to read labels of reagent vials loaded onto the items of labware. The imaging system can ensure that all portions of the workspace of deck 105 are in view of at least one camera. The imaging device can be any suitable device for capturing an image of deck 105 and any components on deck 105 or the entirety of structure 140. The imaging device can comprise one of a plurality of imaging devices mounted to or nearby structure 140 to obtain multiple views of labware and reagent vials disposed on deck 105. For example, the imaging device can be any suitable type of camera, such as a photo camera, a video camera, a three-dimensional image camera, an infrared camera, etc. Some examples can also include three-dimensional laser scanners, infrared light depth-sensing technology, or other tools for creating a three-dimensional surface map of objects and/or a room. In examples, the imaging device can be used to facilitate set-up of processing system 100, such as by verifying proper location of labware or other components within housing (e.g., housing 202 of FIG. 2) or on deck 105, such as by providing control computer 108 inputs regarding the presence or position of labware or components. In additional examples, one or more imaging devices 206 can be used to monitor the location and consumption of pipette tips before, during and after protocol performance, to facilitate defragmenting and reformatting procedures, wherein a protocol is a list of instructions for the fluid handling system to perform the procedures, including pipetting operations.

Control computer 108 can conduct pipette tip organizing for pipette tips loaded onto deck 105 using processing apparatus 101 and including transport device 141, as well as control the processes run on processing system 100, according to a stored protocol. Control computer 108 can control and/or transmit messages to processing apparatus 101, transport device 141, and/or thermal cycler system 107. Control computer 108 can comprise data processor 108A, non-transitory computer readable medium 108B and data storage component 108C coupled to data processor 108A, one or more input devices 108D and one or more output devices 108E. Although control computer 108 is depicted as a single entity in FIG. 1, it is understood that control computer 108 can be present in a distributed system or in a cloud-based environment. Additionally, examples allow some or all of control computer 108, processing apparatus 101, transport device 141, and/or thermal cycler system 107 to be combined as constituent parts in a single device.

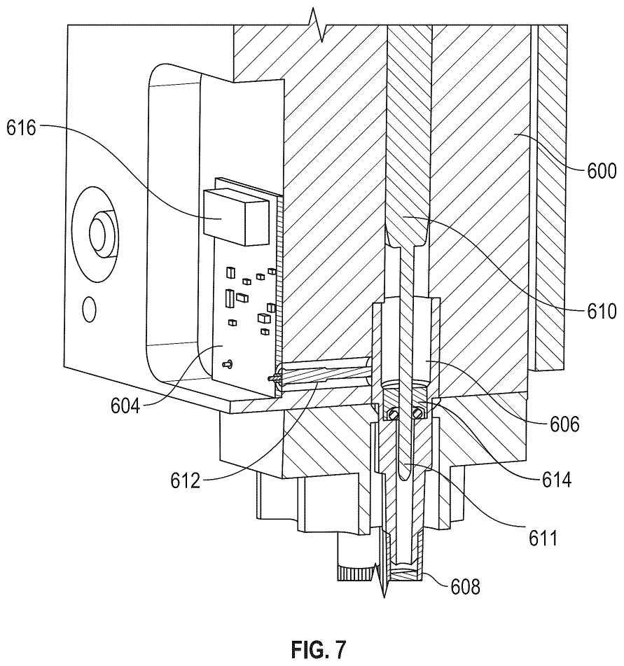

Output device 108E can comprise any suitable device that can output data. Examples of output device 108E can include display screens, video monitors, speakers, audio and visual alarms and data transmission devices. Input device 108D can include any suitable device capable of inputting data into control computer 108. Examples of input devices can include buttons, a keyboard, a mouse, touchscreens, touch pads, microphones, video cameras and sensors (e.g., light sensor, position sensors, speed sensor, proximity sensors). Additionally, input device 108D can comprise a sensor that can receive inputs from transport device 141. In examples, input device 108D can comprise a capacitance sensor (e.g., capacitance sensor 616 of FIG. 7) that can be in electronic communication with tip mandrel 256 (FIG. 3) of transport device 141. As such, electrical capacitance sensed at tip mandrel 256, or a tool loaded therein, can be relayed to, or sensed in conjunction with, the capacitance sensor located in control computer 108. In additional examples, input device 108D can comprise one or more encoders located at transport device 141 to provide location information, such as X, Y, Z coordinates, to control computer 108 regarding the location of tip mandrel 256 and tools loaded therein relative to the workspace of deck 105.

Data processor 108A can include any suitable data computation device or combination of such devices. An exemplary data processor can comprise one or more microprocessors working together to accomplish a desired function. Data processor 108A can include a CPU that comprises at least one high-speed data processor adequate to execute program components for executing user and/or system-generated requests. The CPU can be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The data processor system can include a means of communicating to external devices such as a USB drive for loading user panels or services such as the Beckman Connect instrument diagnostic service.

Computer readable medium 108B and data storage component 108C can be any suitable device or devices that can store electronic data. Examples of memories can comprise one or more memory chips, disk drives, etc. Such memories can operate using any suitable electrical, optical, and/or magnetic mode of operation.

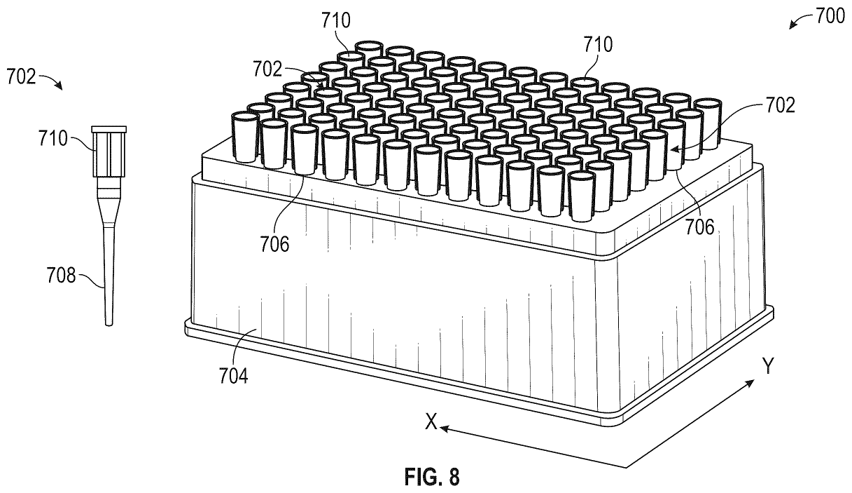

Computer readable medium 108B can comprise code, executable by data processor 108A to perform any suitable method. For example, computer readable medium 108B can comprise code, executable by processor 108A, to cause processing system 100 to perform automated processes, including pipette tip defragmentation and reformatting processes, as well as to control thermal cycler system 107, structure 140, transport device 141, and/or processing apparatus 101 to execute the process steps for the one or more processes described herein, particularly those described with reference to FIGS. 8-14B and the Examples section below that describe pipette tip defragmentation and reformatting methods.

Computer readable medium 108B can comprise code, executable by data processor 108A, to receive and store process steps for one or more pipette tip organizing procedures (e.g., a procedure for arranging or rearranging, formatting or reformatting and/or defragmenting pipette tips within one or more containers. As such, computer readable medium 108B can include three-dimensional location data, such as X, Y, Z coordinates described below, for the location of individual pipette tip sockets or receptacles for pipette tip containers loaded onto deck 105.

Computer readable medium 108B can also include code, executable by data processor 108A, for receiving results from processing apparatus 101 (e.g., results from analyzing a biological sample) and for forwarding the results or using the results for additional analysis (e.g., diagnosing a patient).

Additionally, computer readable medium 108B can comprise code, executable by data processor 108A, for obtaining an image of deck 105, identifying information (e.g., the presence of labware or the location of pipette tips) in the images of deck 105, confirming pieces of labware or pipette tips on deck 105 by comparing stored location information in computer readable medium 108B to location information obtained from an imaging process, and performing pipette tip organizing processes of processing system 100 accordingly.

Data storage component 108C can be internal or external to control computer 108. Data storage component 108C can include one or more memories including one or more memory chips, disk drives, etc. Data storage component 108C can also include a conventional, fault tolerant, relational, scalable, secure database such as those commercially available from Microsoft SQL, Oracle™ or Sybase™. In some examples, data storage component 108C can store protocols 108F and images 108G. Data storage component 108C can additionally include instructions for data processor 108A, including protocols. Computer readable medium 108B and data storage component 108C can comprise any suitable storage device, such as non-volatile memory, magnetic memory, flash memory, volatile memory, programmable read-only memory and the like.

Protocols 108F in data storage component 108C can include information about one or more protocols. A protocol can include information about one or more processing steps to complete (e.g., pipetting processes, procedures or operation), components used during the process (e.g., pipette tips), a component location layout (e.g., X, Y, Z coordinate locations for pipette tips), loading of thermal cycler system 107, heating levels of thermal cycler system 107 and/or any other suitable information for completing a process. For example, a protocol can include one or more ordered steps for processing a biological sample or processing a DNA library. A protocol can also include steps for preparing a list of components before starting the process, such as the number of pipette tips to be used in each pipetting operation. The components can be mapped to specific locations in the reaction vessel (e.g., reaction vessel 205 of FIG. 2) or in the carousel (e.g., carousel 204 of FIG. 2) or deck (e.g., deck 105) or pipette tip container (e.g., pipette tips 702 in tip rack 700 of FIG. 8) where transport device 141 can obtain the components in order to transport them or the container they are loaded into to processing apparatus 101 or thermal cycler system 107. This mapping can be encoded as instructions for operating transport device 141, such as instructions directing a pipettor including a pipette tip to aspirate a volume of liquid from a reaction vessel in the carousel and to dispense the volume at a predetermined destination, and the mapping can also be represented by a virtual image shown to a user such that the user can place the components on deck 105, the reaction vessel and the carousel. Examples allow processing system 100 to be used for multiple processes (e.g., multiple different sample processes or preparation procedures). Accordingly, information about multiple protocols 108F can be stored and retrieved when needed. As described herein, components, particularly pipette tips, on deck 105, the reaction vessels and the carousel can be automatically rearranged, changed, and/or replenished as necessary, when changing from a first process to a second process within a protocol, or when re-starting a first process within the protocol, or changing from a first protocol to a second protocol. In order to properly execute protocols, it is desirable for control computer 108 to know how to manipulate transport device 141 to move the working tool to the desired three-dimensional location within the workspace of deck 105.

Images 108G in data storage component 108C can include a real-world visual representation of deck 105, pipette tips, the reaction vessels and the carousel, as well as of components disposed on or in deck 105, pipette tip containers, the reaction vessels and the carousel and labels disposed on those components. In each image, deck 105, the reaction vessels and the carousel can be shown in a ready state for beginning a certain process, with components for executing a protocol placed in locations accessible to transport device 141. Each of images 108G can be associated with a specific protocol from the stored protocols 108F. In some examples, there can be a single image for certain protocol. In other examples, there can be multiple images (e.g., from different angles, with different lighting levels, or containing acceptable labware substitutions in some locations) for a certain protocol. Images 108G can be stored as various types or formats of image files including JPEG, TIFF, GIF, BMP, PNG, and/or RAW image files, as well as AVI, WMV, MOV, MP4, and/or FL V video files. As such, images 108G can provide information to control computer 108 regarding the presence of labware and pipette tips on deck 105 and proper positioning of such components, as well as the quantity of such components that are available and the number of open locations or receptacles for such components.

Deck 105 can be subdivided into a plurality of discrete deck locations for staging different components. The discrete locations can be of any suitable size. An example of deck 105 with a plurality of locations is shown loaded with labware in FIG. 4 and unloaded in FIG. 5. Deck 220 in FIG. 4 shows separate areas numbered L1 through L16, as well as thermal cycler system 208, which can operate as a separate location for separate types of components or packages of components. Deck 105 can have additional locations or fewer locations as desired. While these locations can be numbered or named, they can or cannot be physically labeled or marked on deck 105 in physical embodiments of the system.

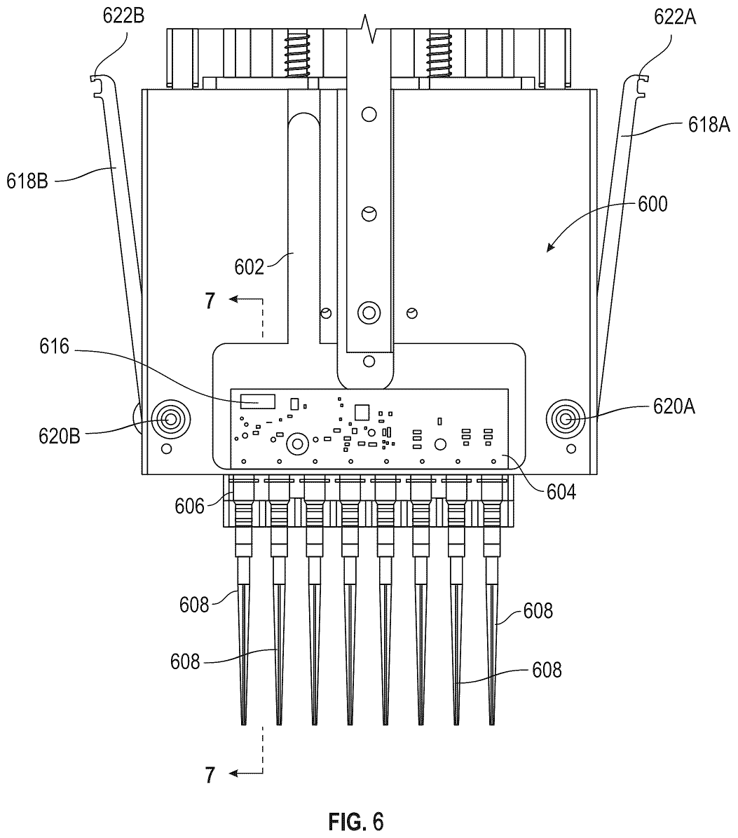

As discussed herein, processing system 100 can execute pipette-tip organizing procedures for processing system 100 including performing reformatting and defragmenting procedures using transport device 141 (FIG. 2) and pipetting device 600 (FIG. 6). In particular, as is described in greater detail with reference to FIGS. 14A and 14B, processing system 100 can: 1) determine the starting set of pipette tips to be used for a protocol, 2) determine the location of all the pipette tips in the starting set, 3) monitor the consumption of pipette tips during performance of a protocol, 4) record the location of unfilled or open pipette-tip receptacles in a pipette tip container, 5) move pipette tips from within the pipette tip receptacle to different receptacles, 6) move pipette tips from within a different pipette-tip container to receptacles in the pipette tip container, and 7) organize pipette tips within receptacles of the pipette tip container to reduce empty spaces and increase efficient pipette tip loading onto a pipetting device. The organizing procedures described herein can be conducted by processing system 100 without the assistance of, or with minimal assistance of, operator intervention and with reduced times as compared to typical procedures.

FIG. 2 is perspective view of fluid handling system 200 that can comprise an example of processing system 100 of FIG. 2. Fluid handling system 200 can comprise housing 202, carousel 204, reaction vessel 205, imaging device 206 and thermal cycler system 208. Note, components of FIG. 2 are not necessarily drawn to scale for illustrative purposes. Housing 202 can comprise a plurality of walls or panels that form an enclosure into which carousel 204 and reaction vessel 205 can be positioned. The enclosure can have an opening over which cover panel 210 can be positioned to encapsulate carousel 204, imaging device 206 and thermal cycler system 208 within the enclosure. Housing 202 can additionally include platform 212 on which a deck, such as deck 105 (FIG. 1) or deck 220 (FIG. 3) can be positioned. The deck can include various sockets, slots or receptacles (e.g., receptacles 300, 302, 304 and 306 of FIG. 5) for receiving carousel 204, one or more of reaction vessel 205, pipette tip racks and the like. In examples, the sockets, slots or receptacles can be configured to hold carousel 204, reaction vessel 205, pipette tips and the like in predetermined or known positions relative to transport device 141 (FIG. 1, FIG. 3) and imaging device 206. Platform 212 can hold the deck and contents therein in a predetermined or known position relative to housing 202. Housing 202 can additionally comprise space for holding controller 214, such as those of control computer 108 (FIG. 1). Controller 214 can be configured to communicate with network 216, such as via a wireless or wired communication link.

Imaging device 206 can be located within housing 202 in a stationary location. However, imaging device 206 can be moveable or have an adjustable field of view. One or more imaging devices 206 can be configured to point at a single location or multiple locations in housing 202. Simultaneously, dispenser tip 258 (FIG. 3) of transport device 141 and processing apparatus 101 (FIG. 1) can be located within housing 202 to access locations on platform 212. Transport device 141 can additionally be configured to move reaction vessel 205 into thermal cycler system 208, as well as other items of labware to any of locations L1-L16 (FIG. 4). Carousel 204 can spin or rotate to present different locations to a fluid dispenser, e.g., dispenser tip 258 (FIG. 3) or pipette tip 608 (FIG. 6), and imaging device 206. In other examples, a single imaging device 206 can be mounted within housing 202 to move a viewing area over different portions of the interior of housing 202.

Fluid handling system 200 can further comprise transport device 141 (FIG. 1), that can comprise a system for moving a fluid dispenser to different three-dimensional locations within housing 202, as is described with reference to FIGS. 3-5. The organizing procedures described herein can be performed by transport device 141 moving the fluid dispenser within housing 202 to move unused pipette tips between locations in one or more pipette tip containers to consolidate fragmented pipette tips or format pipette tips into useful patterns from pipette tips that may be scattered within one or more pipette tip containers due to the performance of a protocol, as is described in greater detail with reference to FIGS. 8-14B.

FIG. 3 a schematic diagram illustrating platform 212 of FIGS. 4 and 5 with labware piece 230 positioned within receptacle 232 of deck 220 and positioned relative to transport device 141 and imaging device 206. Receptacle 232 can comprise walls 234A-234D. Transport device 141 can comprise an overhead crane system having rails 240A and 240B that run across a length of platform 212 and bridge 242 that can span the width of platform 212. Bridge 242 can be configured to slide on rails 240A and 240B, such as via wheels 244A and 244B. Carriage 246 can be coupled to bridge 242 and can be configured to move along bridge 242 across the width of platform 212. Bridge 242 and carriage 246 can be operatively coupled to one or more motors 248 and power sources (not shown), as well as controller 214 (FIG. 2) or control computer 108 (FIG. 1), to move according to a reformatting or defragmentation procedure. Carriage 246 can comprise trolly 250 having wheels 252A and 252B, fluid dispenser 254 and tip mandrel 256. In the illustrated example, tip mandrel 256 is reversibly coupled to dispenser tip 258. In examples, dispenser tip 258 can comprise a pipette tip, such as pipette tip 702 of FIG. 8. Dispenser tip 258 can be configured to move axially in the Z direction via telescoping action of tip mandrel 256, carriage 246 can be configured to move axially in the X direction on bridge 242, and bridge 242 can be configured to move axially in the Y direction on rails 240A and 240B. In some examples, fluid dispenser 254 is coupled to a robotic arm configured to move the fluid dispenser 254 axially in the Z direction to provide vertical movement and positioning of the dispenser tip 258. As such, dispenser tip 258 can be moved to engage receptacle 232 and labware piece 230 and move liquid to and from labware piece 230 from other locations on deck 220. Motor 248 can comprise one or more motors for moving trolly 250 by activating wheels 252A and 252B, moving bridge 242 by activating wheels 244A and 244B, and moving tip mandrel 256 relative to fluid dispenser 254, such as by moving a linear actuator. Motor 248 can comprise a stepper motor wherein the position of a component of motor 248 relative to the rest of motor 248 can be translated into an X, Y, or Z position in the coordinate system.

According to the present disclosure, transport device 141 can be operated by controller 214 to engage a tip of dispenser tip 258 or tip mandrel 256 of fluid dispenser 254 if dispenser tip 258 is not installed in tip mandrel 256 to sense the presence of items located on deck 220, such as liquid, labware and pipette tips, such as by using a capacitive sensing system. Fluid dispenser 254, tip mandrel 256 extending therefrom, and dispenser tip 258, as well as other conducting or semi-conducting instruments attached to tip mandrel 256, can be configured to be in electrical communication with a capacitance sensor located, for example, in controller 214 (FIG. 2), carriage 250, fluid dispenser 254, or another location in or on housing 202. In an example, fluid dispenser 254 and the associated capacitance sensor can be configured as tip mandrel 606 and capacitance sensor 616 of FIGS. 6 and 7. In examples, the capacitance sensor can comprise a CapSense® sensor from Cypress Semiconductor. In additional examples, pipettes or pipette tips attached to tip mandrel 256 can be fabricated from plastic infused or embedded with conducting material. Thus, processing system 100 can utilize a conductive tip to sense a magnitude of a capacitance between the tip and the container of conductive fluid is measured. This magnitude can be correlated to data stored in memory available to processing system 100 to determine a level of the liquid surface. Similarly, processing system 100 can determine if tip mandrel 256 is in contact with a conducting pipette tip in order to determine the presence or absence of a pipette tip at locations (e.g., X, Y, Z coordinate positions) within a pipette tip container. Examples of capacitance sensing circuits are described in U.S. Pat. No. 4,912,976, titled “Liquid level sensing apparatus” to inventor Labiola, II, U.S. Pat. No. 4,736,638, titled “Liquid level sensor” to inventors Okawa et al., and U.S. Pat. No. 7,275,430, titled “Method and apparatus for detecting liquid levels in liquid-storage containers” to Zuleta et al., each of which are incorporated herein in their entirety by this reference. In other examples, processing system 100 can determine the presence or absence of a pipette tip at locations (e.g., X, Y, Z coordinate positions) within a pipette tip container using imaging device 206 as described elsewhere herein. In still other examples, the presence or absence of a pipette tip at a specific location can be determined by detecting a change in resistance of motion of the tip mandrel 256 as the tip mandrel 256 is lowered to engage a pipette at that specific location. This change in resistance can be detected by a pressure sensor, by a position encoder that indicates a reduction in movement compared to a commanded movement, or by any other suitable means. In yet other examples, the locations of open pipette tip receptacles and filled tip receptacles within a pipette tip container may be determined by monitoring the consumption of pipette tips according the protocol being run, assuming that the pipette tip container was full at the beginning of the run.

As is discussed in greater detail below, controller 214 (FIG. 2) can be configured to execute pipette tip defragmentation or reformatting procedures for pipette tips loaded into a container to reduce or eliminate the need for an operator to manually replenish or organize leftover pipette tips after a protocol has run. In examples, controller 214 can be configured to operate transport device 141 to contact pipette tips within containers loaded onto platform 212 or deck 220 with a sensor connected to or mounted on transport device 141. For example, fluid dispenser 254 or dispenser tip 258 can be provided with a sensor such as a capacitance sensor. Inherent structural features of pipette tips that are loaded into a tip tray disposed on deck 220 can be contacted and the location of tip mandrel 256 in three-dimensional X, Y, Z coordinates can be recorded so that controller 214 can know the location of pipette tips at that specific location. If fluid dispenser 254 does not contact a pipette tip, a capacitance reading will not occur and controller 214 can know that a pipette tip is absent from that location.

Thus, contact of a pipette tip can establish that a receptacle in the container is occupied and the absence of contact with a pipette tip can establish that a receptacle in the container is empty. The occupied/empty information read from these sensors can be connected to control computer 108 (FIG. 1) to be compared to information, such as information obtained from network 216 (FIG. 2) or stored in a computer readable medium, such as medium 108B of FIG. 1 or provided by the operating method. The information stored in the computer readable medium can include protocol information that includes the number and locations of pipette tips to be used in the protocol, where they should be retrieved from and the number and locations of pipette tips that may be left over or remain after the protocol is performed, or at any point during the performance of the protocol. Additionally, complete geometric information (e.g., dimensions, sizes, tolerances, etc.) for pieces of labware and pipette tips that can be positioned within each of receptacles 300, 302, 304 and 306 can be stored in medium 108B of FIG. 1 or be made available via network 216 (FIG. 2).

Controller 214 (FIG. 2) can be configured to perform different pipette tip organizing procedures, such as filling of containers, filling of rows or columns in a receptacle array of a container, formatting pipette tips into patterns or groupings that facilitate performance of steps of a protocol, and defragmenting groups of pipette tips or individual pipette tips to eliminate or reduce gaps between pipette tips. Examples of organizing procedures are discussed with reference to FIGS. 8-14B.

FIG. 4 is a plan view of deck 220 for loading onto platform 212 of housing 202 of FIG. 2 with labware loaded thereon. FIG. 5 is a plan view of deck 220 of FIG. 3 without the labware loaded thereon. Unless specifically noted otherwise, FIGS. 4 and 5 are discussed concurrently.

Deck 220 can include spaces or locations L1-L16 for various components, including carousel 204, reaction vessels 205, pipette tip racks (or micro-tip racks) 218, milli-tip racks 221, bulk reservoirs 222 and waste bin 224. Other locations can be provided for other items of labware, such as tube holders and reagent tube holders. Deck 220 can also be configured to represent examples comprising a plurality of modules with predefined and fixed operational locations, where these modules may comprise complete subsystems that perform dedicated functions. For example, a module may perform specimen or prepared sample washing while another may present primary specimens to the transport device 141 for specimen aliquot.

One or more imaging devices 206 can be mounted within housing 202 relative to platform 212 such that imaging device can produce a field of view that covers all of platform 212. Likewise, a transport system, such as transport device 141 of FIGS. 1 and 3, can be configured to move fluid dispenser 254 around the entirety of platform 212.

FIG. 4 shows deck 220 including locations numbered L1-L16, as well as other components such as thermal cycler system 208, which can operate as a separate location for separate types of components or packages of components. Examples of deck 220 can have additional locations or fewer locations, as desired. While these locations can be numbered or named, the locations may or may not be physically labeled or marked on deck 220 in physical embodiments of fluid handling system 200. In examples of fluid handling system 200, some or all of the locations can be occupied by a pre-defined type of component according to a certain protocol. For example, locations L1-L10 can be loaded with micro-tip racks or pipette tip racks. Specifically, in examples, locations L1-L4 can comprise storage locations for pipette tip racks or micro-tip racks 218 and location L5-L10 can comprise storage locations for milli-tip racks 221 that can be loaded with a component of a package or reagent kit or a component as specified by a protocol, and location L11 can be loaded with carousel 204. Racks 218 and 221 can be used in place of reaction vessel 205 with reference to FIG. 2 and labware piece 230 with reference to FIG. 3. Racks 218 and 221 can additionally comprise an instance of pipette tip rack 700 of FIG. 8, in which case racks 218 and 221 may serve as a source for unused pipette tips and/or a location for receiving and disposing of used pipette tips. Location L12 can comprise a cold reagent storage area for reaction vessels 205. Location L13 can comprise a warm reagent storage area for reaction vessels 205. Location L15 can comprise a storage area for bulk reservoirs 222. Location L14 can comprise an RV stack storage area for reaction vessels 205. Locations L14 and L15 can be interchanged in various systems. Location L16 can comprise a waste storage area for bin 224, such as where used pipette tips can be disposed of or liquid from used pipette tips can be disposed of. In examples, used pipette tips can be disposed in other items of labware, such as a tip tray designated for used pipette tips. Some of locations L1-L16 can include the same type of component. The components can comprise test tubes, microwell or microtiter plates, pipette tips, plate-lids, reservoirs or any other suitable labware component. The components can also comprise an item of laboratory equipment, such as a shaker, stirrer, mixer, temperature-incubator, vacuum manifold, magnetic plate, thermal cycler, or the like.

One or more of locations L1-L16 can be programmed to processing system 100 to be the location for receiving trays, boxes or racks of pipette tips. Such receiving trays, boxes, or racks may contain unused pipette tips for performing pipetting operations, or may contain used pipette tips placed into the receiving trays, boxes, or racks after a pipetting operation. Processing system 100 can be provided with the X, Y, Z coordinates of locations L1-L16 and the geometry of labware configured to be stored in locations L1-L16. For example, the geometry of a pipette tip rack including sockets or receptacles for pipette tips can be converted to X, Y, Z coordinates stored in memory. Thus, processing system 100 can be configured to know the three-dimensional position of the sockets or receptacles relative to deck 220 such that the position of a pipette tip within the sockets or receptacles or the absence of a pipette tip at such socket or receptacle can be determined and recorded in memory, such as by using the imaging system or a sensing system of the fluid dispenser.

Each of locations L1-L16 can be accessed by transport device 141 (FIG. 1). For example, locations L1-L16, and thermal cycler system 208 can be physically separate from structure 140 or deck 220. As shown in FIG. 5, locations L1-L16 can comprise, sockets, slots or receptacles into which other components, e.g., labware and tip trays, can be positioned and held stationary in known locations relative to transport device 141.

For example, bulk reservoirs 222 (FIG. 4) can be positioned in bulk reaction vessel receptacle 300 (FIG. 5), reaction vessel 205 (FIG. 3) can be positioned in reaction vessel receptacle 302 (FIG. 5), milli-tip racks 221 (FIG. 4) can be positioned in rack receptacle 304 (FIG. 5) and thermal cycler reservoir 205T (FIG. 4) can be positioned in thermal cycler reaction vessel receptacle 306 (FIG. 5). Additionally, pipette tip rack 700 of FIG. 8 can be positioned in one of rack receptacle 304 (FIG. 5).

Imaging device 206 can be configured to recognize the presence of one or more components at each of locations L1-L16 the presence of carousel 204 at location L11 and the presence of reaction vessel 205 at locations L12, L13 and L14, for example. Components, e.g., vials of liquid, can be loaded into carousel 204 is a desired manner, e.g., according to a protocol and liquid therefrom, or another location, can be loaded into one of reaction vessels 205 for loading into thermal cycler system 208 according to the protocol. Imaging device 206 can be used to identify a component loaded onto deck 220 and verify that the identified component is the expected component. In further examples, imaging device 206 can indicate that a component other than the expected component has been loaded, or that the expected component has been loaded improperly (such as crooked). In examples, imaging device 206 can be used to confirm the presence, shape and proper loading of the component.

In examples, imaging device 206 can be used according to the principles and methods described in WO 2021/041216 to Davis et al., which is incorporated herein in its entirety by this reference, to identify items on deck 220 and the locations of such items on deck 220.

As a particular non-limiting example of component verification, a deck setup configuration can require that a particular size and/or type of pipette tip container, such as a 96- or 384-pipette tip box, be arranged at a particular location on deck 220. Machine learning or an artificial neural network can be used to examine images of deck 220 with respect to the location where the pipette tip container is desired. Machine learning or an artificial neural network can be trained, programmed, or otherwise configured to determine whether an item positioned in the particular location on deck 220. In particular, machine learning or an artificial neural network can determine whether the item on deck 220 is a 96-pipette tip box; (2) a 384-pipette tip box or (3) a different item. If the item is determined to be a 96-pipette tip box, it can be determined that the location is satisfied. If the item is determined to be a different item, an error can be recorded to alert the operator that the item is incorrect.

Additionally, in some examples, the machine learning or artificial neural network can determine whether the item on deck 220 is configured or arranged correctly where a particular configuration or arrangement of the component is required or desired. For example, it can be determined whether the item on deck 220 is: (1) a 96-pipette tip box without a lid; (2) a 96-pipette tip box with a lid; (3) a 384-pipette tip box without a lid; (4) a 384-pipette tip box with a lid; or (5) a different item. If it is determined that the item on deck 220) is the correct box but contains a lid or other covering, an error can be recorded to alert an operator to remove the lid for processing.

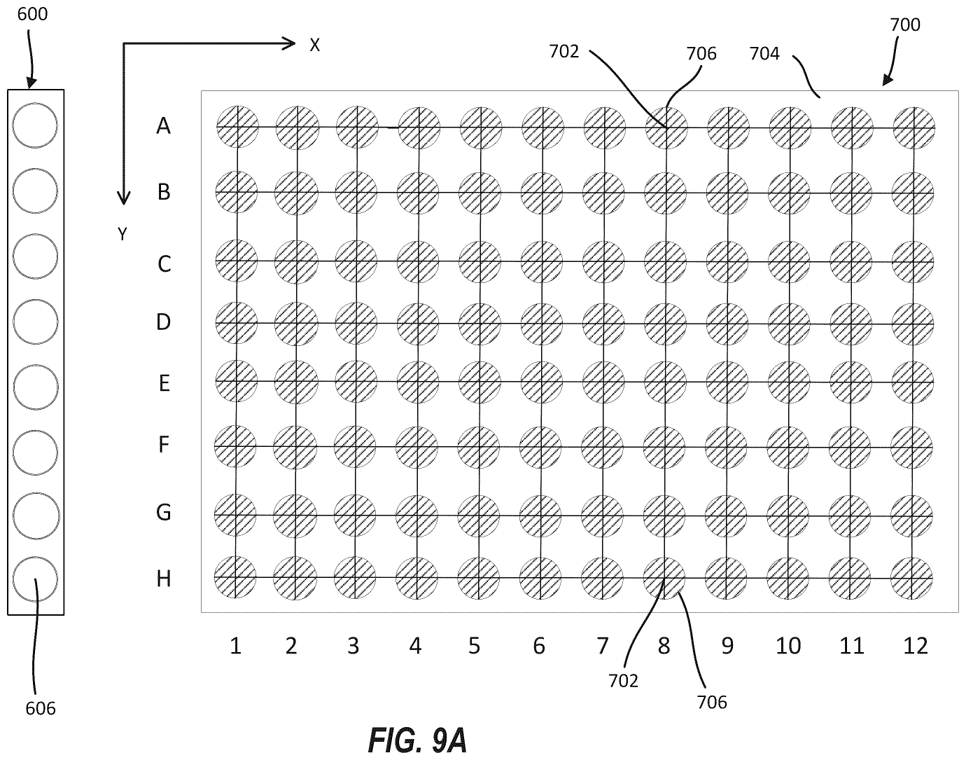

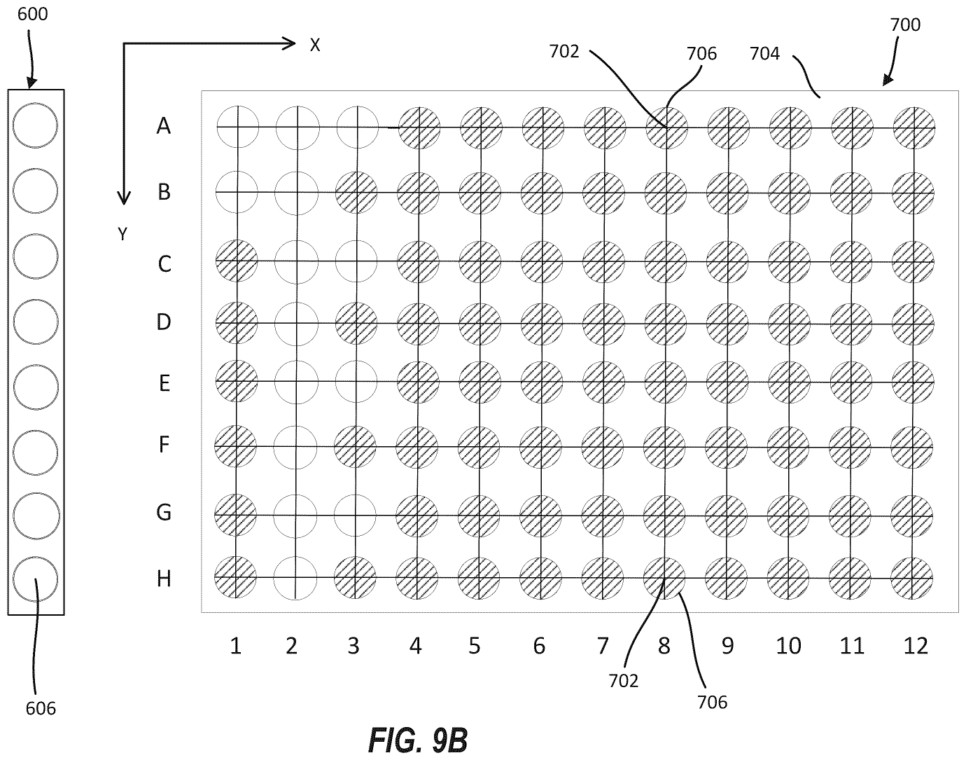

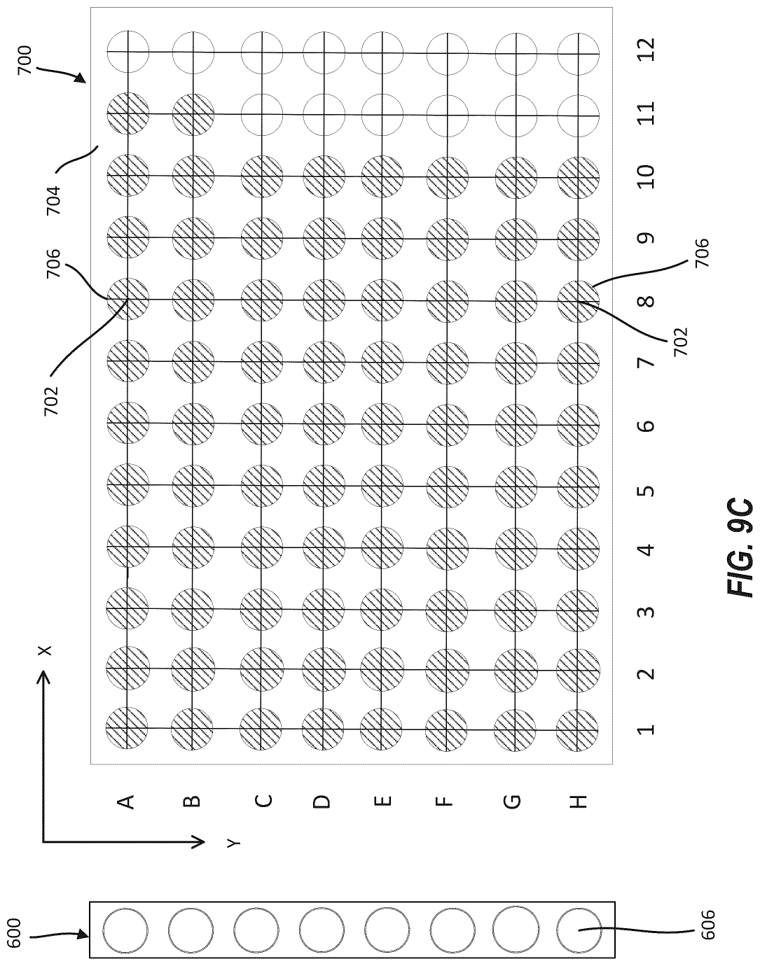

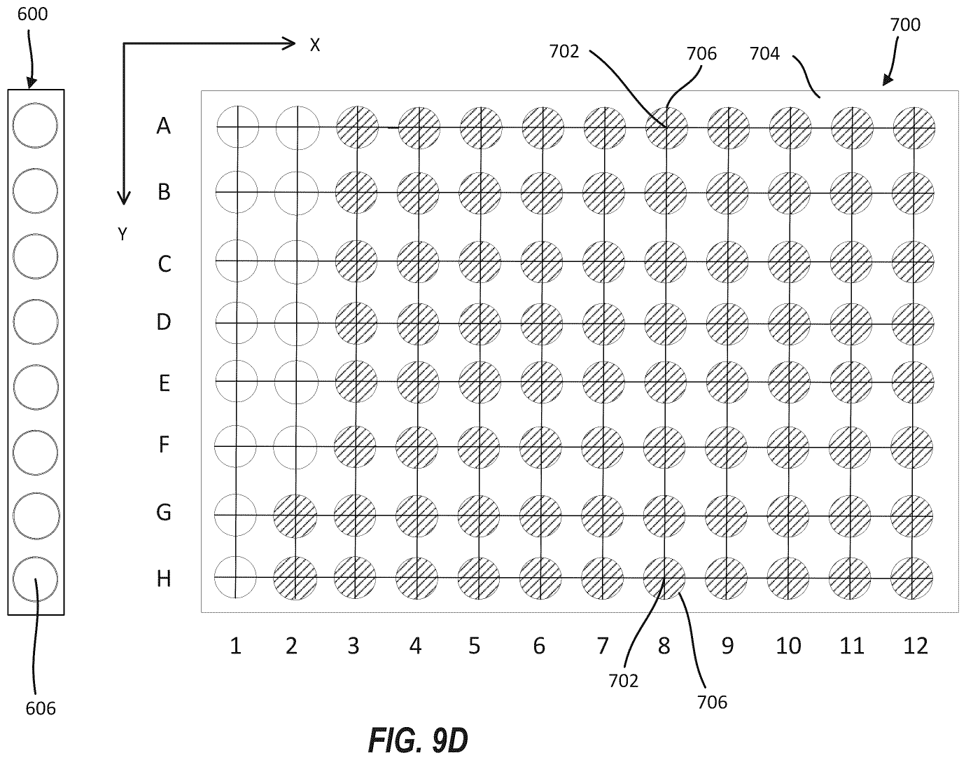

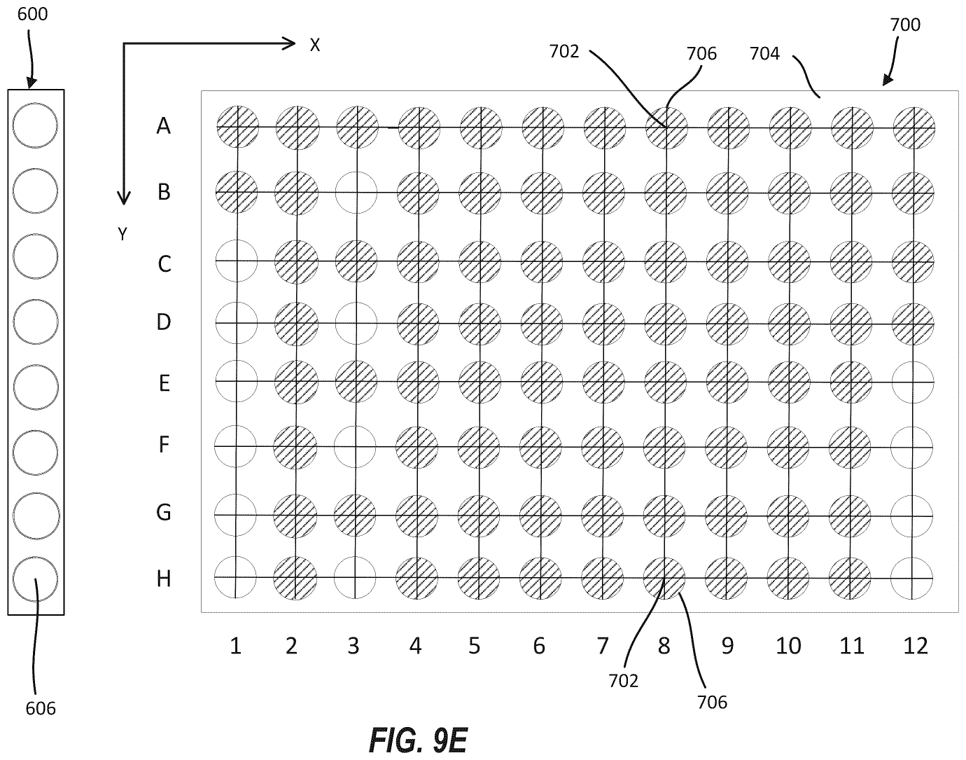

Additionally, if the deck setup configuration requires that the box contain a particular number and/or configuration of tips or of openings without tips, template matching, for example, can be used to identify and count a number of tips or openings in the image of the box. FIG. 9A shows a close-up view of an example pipette tip rack having a number of tips 702 and receptacles 706 for holding tips 702. Template matching can be used to compare the image of deck 220 with one or more stored template images of a tip or a tip opening. Thus, for example, template matching can be used to compare the image of deck 220 with x-stored template images of a tip or a tip opening, wherein “x” corresponds to the number of tips or tip openings. Using x-stored template images can be helpful in situations where, e.g. deck lighting casts a different shadow on the tips in the same tipbox; and/or the perspective distortion of the camera results in different view of the tips in the same tipbox. Thus, template matching can be employed to identify each open receptacles 706 of the item on deck 220 and to count a total number of openings to determine whether the box contains a correct number and/or pattern of openings (and thus by extension, a correct number and/or pattern of tips). In other examples, the tips 702 may be identified and counted instead of, or in addition to, the openings. Those of skill in the art will recognize that the ability to count the total number of openings can be determined, at least in part, by angles of the camera mounting. For example, depending on a camera angle, some of the tip openings can be blocked by the adjacent tips. As a result, it can be helpful to use the tips as templates, instead of the openings in a tipbox, when a camera angle is used that causes one or more tips to block the view of one or more adjacent openings.

In some examples, deck setup instructions may be dynamically modified in response to component verification. For example, where an operator is instructed to load a particular number of tips onto the deck, and the operator loads fewer than the particular number of tips, a system of the present disclosure may calculate an additional number of tips still needed and instruct the operator to load the additional number of tips. As a particular example, where a particular run or method to be performed requires ninety-six tips, and the operator loads two boxes each containing forty-eight tips, the system may verify proper deck setup for that component or location on the deck. However, if the operator loads two partial boxes, each box containing only twenty tips, the system, upon counting the number of tips present, can calculate that fifty-six tips are still needed. The system may then instruct the operator to load an additional fifty-six tips.

As another particular non-limiting example of component verification, a deck setup configuration can require that a particular size and/or type of pipette tip container, such as a 384-pipette tip box, be arranged at a particular location on deck 220. Machine learning or an artificial neural network may be used to examine the deck image with respect to the location on deck 220 where the pipette tip container is required. Machine learning or an artificial neural network can be trained, programmed, or otherwise configured to identify whether an item arranged in the location on deck 220 is: (1) a 384-pipette tip box without a lid; (2) a 384-pipette tip box with a lid; or (3) a different item. Template matching can be used to identify and count each tip in the box to determine whether the box contains a correct number and/or pattern of openings. In other examples, each opening can be identified and counted using template matching.

FIG. 6 is a perspective view of pipetting device 600 that can be coupled to transport device 141. In examples, pipetting device 600 can be connected to carriage 250 (FIG. 3) to be mobile within the workspace of fluid handling system 200 (FIG. 2). Pipetting device 600 can include various cables and connectors for electronically coupling the pipetting device 600 and components thereof to controller 214. For example, pipetting device 600 can comprise cable 602 that can connect circuit board 604 to controller 214. Tip mandrel 606 can be connected to pipetting device 600, which can include spaces to couple to multiple pipette tips 608. In the illustrated example, pipetting device 600 can hold 8 pipette tips 608.

FIG. 7 is a cross-sectional view of pipetting device 600 of FIG. 6 taken at section 7-7 showing circuit board 604, tip mandrel 606, pipette tip 608, plunger 610 and connector pin 612. FIGS. 6 and 7 are discussed concurrently.

Tip mandrel 606 can comprise a device to which a pipette tip 608 can be connected. In examples, tip mandrel 256 of FIG. 3 can be configured similarly to tip mandrel 606. Tip mandrel 606 can include sealed cap 614 through which shaft 611 of plunger 610 can be extended. Plunger 610 can be activated by pipetting device 600, such as via controller 214, to draw a vacuum within pipette tip 608, similar to a syringe. Each tip mandrel 606 can be connected to a plunger 610 so that all of pipette tips 608 can be actuated at the same time whether or not they are each actually performing a pipetting function. As such, transport device 141 can move pipetting device 600 around the workspace so that pipette tips 608 can be inserted into a volume of liquid, plunger 610 can be retracted (moved upward with reference to FIG. 7) to draw liquid into pipette tip 608 and moved to another position to dispense the liquid by downward movement of plunger 610.

Circuit board 604 can comprise a liquid level sensor board that is configured to sense capacitance. As such circuit board 604 can comprise capacitance sensor 616 that can be in electronic communication with connector pin 612. Connector pin 612 can provide an electrical connection between tip mandrel 606 and pipette tip 608 coupled thereto. In an example, connector pin 612 can comprise a pogo pin. For example, capacitance sensor 616 can be used to sense the level of liquid within a vial or container into which a pipette tip is inserted into, as can be appreciated by one of skill in the art. Furthermore, capacitance sensor 616 can be used to sense the position of tip mandrel 606 when contacted to a conducting surface. Additionally, if a conductive pipette tip 608 is coupled to mandrel 606, capacitance sensing can be conducted using pipette tips 608.

As can be seen in FIG. 6, pipetting device 600 can further comprise gripper arms 618A and 618B, which can be coupled to pipetting device 600 at pivot points 620A and 620B, respectively. Gripper arms 618A and 618B can include gripping features 622A and 622B, respectively, such as teeth, flanges or fingers that can couple to an item of labware. For example, gripping features 622A and 622B can latch onto an edge of an item of labware so that transport device 141 can be used to move the item of labware around the workspace. Gripper arms 618A and 618B can be electronically coupled to capacitance sensor 616. Gripper arms 618A and 618B can be motorized so a to be automatically controlled with control computer 108 (FIG. 1) to perform protocols.

Incorporating capacitance sensor 616 into pipetting device 600 to be in electric communication with tip mandrel 606 can allow for configurations that facilitate execution of various features described herein, including reformatting and defragmenting processes.

As shown in FIGS. 6 and 7, some examples of the present disclosure can include a pipettor or liquid dispenser that includes multiple channels. Each of these liquid-conducting channels can be coupled to a different capacitance sensor, e.g., a separate instance of capacitance sensor 616, to allow independent checking or calibration of each channel. For example, each of pipette tips 608 shown in FIG. 6 can be electronically coupled to an instance of capacitance sensor 616 to allow for independent function check operations to be conducted with each pipette tip 608.

FIG. 8 is a perspective view of pipette tip rack 700 at full capacity of unused pipette tips 702. Pipette tip rack 700 can comprise body 704 having receptacles 706. Pipette tip rack 700 can be configured to hold a plurality of pipette tips 702 in a predetermined array or pattern so that pipetting device 600 can be guided by control computer 108 to positions where pipette tips 702 can be gathered. In the illustrated example, rack 700 includes an eight by twelve rectangular array of pipette tip receptacles 706.

Body 704 of rack 700 can comprise a rectilinear body configured to fit within one of rectilinear spaces L1-L10, for example. The outer perimeter of body 704 can be configured to nest between barriers or walls of one of receptacles 304 (FIG. 5) so that body 704 can be repeatably positioned at the same location on deck 220. Thus, as pipette tip racks 700 are emptied or depleted of pipette tips 702, new pipette tip racks 700 full of clean, unused pipette tips 702 can be situated on deck 220 in a place where pipette tips 702 are in the same X, Y, Z locations.

Pipette tips 702 can comprise pipetting shaft 708 and collar 710. Collar 710 can comprise a proximal end of pipette tip 702 that has an internal diameter configured to engage tip mandrel 606 (FIG. 7). Pipetting device 600 (FIG. 6) or tip mandrel 606 can be moved up and down, in the Z direction, to engage collars 710 and remove pipette tips 702 from rack 700. Pipetting device 600 can additionally include features to remove pipette tips 702 from tip mandrel 606. For example, shaft 611 of plunger 610 can be fully extended to push pipette tips off of tip mandrel 606. Alternatively, pipetting device 600 can include a shuck plate configured to engage collar 710 to push pipette tips off of tip mandrel 606. Shaft 708 can comprise a distal end of pipette tip 702 that has an internal lumen configured to fluidly connect to a fluid passage within tip mandrel 606. Shaft 611 of plunger 610 (FIG. 7) can be inserted into shaft 708 to draw fluid into shaft 708 for performing pipetting.

Receptacles 706 can comprise cylindrical slots or bores within body 704 that can receive shafts 708 of pipette tips 702. Collars 710 of pipette tips 702 can rest on body 704 so to be engageable by tip mandrel 606. Receptacles 706 can be arranged in a pattern to maximize the cross-sectional area of body 704 to receive as many pipette tips 702 as possible given the size of pipette tips 702. In examples, receptacles 706 can be arranged in rectangular arrays of rows and columns. In the illustrated example, receptacles 706 can be arranged in an array of eight rows and twelve columns, as shown in FIG. 9A.

FIG. 9A is a schematic map of pipette tip rack 700 of FIG. 8 showing locations of receptacles 706 for placement of unused pipette tips 702 in pipette tip rack 700. FIG. 9A also schematically illustrates an example of pipetting device 600 having eight tip mandrels 606. Pipetting device 600 is oriented so that tip mandrels 606 are aligned in the Y direction. Pipetting device 600 can move in the X and Y direction to position tip mandrels 606 above receptacles 706. In some examples, pipetting device 600 of the illustrated example can be moved in the Z direction to simultaneously engage and pick up eight pipette tips 702 that are located in receptacles 706. In other examples, each tip mandrel 606 of the illustrated pipetting device 600 is independently movable in the Z direction, so that any number of the eight tip mandrels 606 can be lowered to simultaneously engage and pick up a pipette tip 702.

As shown in FIG. 9A, the columns are labeled 1 through 12 and the rows are labeled A through H. Note, grid lines are shown in FIG. 9A for illustrative purposes. As can be seen in FIG. 9A, each of receptacles 706 is schematically shown as being occupied by a pipette tip 702, indicated by cross-hatching. FIG. 9A can illustrate a state of pipette tip rack 700 as being full or at maximum capacity such that each of receptacles 706 is occupied by a pipette tip 702. As such, FIG. 9A can represent a brand-new box from the manufacturer that was packaged with a full array of pipette tips 702 or a pipette tip tray or rack 700 that has been filled by an operator using partial pipette tip boxes, racks or trays. FIG. 9A illustrates a typical configuration, i.e., full, of a starting set for pipette tip rack 700 at the beginning of a protocol to be performed by processing system 100 and fluid handling system 200. Thus, pipette tip rack 700 is fully formatted and pipette tips 702 are not fragmented. However, over the course of performing a protocol, as pipette tips 702 are consumed, pipette tip rack 700 can become partially populated with pipette tips 702 fragmented throughout disparate and unconnected, e.g., non-adjacent, receptacles 706.

Examples of pipette tip defragmenting and reformatting are described below in relation to FIGS. 9B to 11C.

FIG. 9B illustrates the usage of pipette tips 702 in the fully-loaded pipette tip rack 700 of FIG. 9A, according to an exemplary protocol. As such, pipette tip rack 700 includes filled receptacles 706 and open receptacles 706. Filled receptacles 706 are indicated by cross-hatched circles and can represent locations where fluid handling system 200 did not remove a pipette tip 702 from the full array of pipette tips 702 during performance of the protocol. Open receptacles 706 are indicated by unfilled circles and can represent locations where fluid handling system 200 removed a pipette tip 702 from the array to perform a pipetting procedure of a protocol.

In this exemplary protocol, a first pipetting operation is performed comprising two consecutive pipetting steps using a single-channel pipetting device 600, where a different pipette tip 702 is used for each step, thereby removing pipette tips A1 and B1 from pipette tip rack 700.

Situations may arise where columns 1 through 12 have fewer pipette tips 702 available than what is called for in the protocol. As such, pipetting device 600 may need to move to different column where sufficient pipette tips are available for the next pipetting operation even though pipette tips 702 remain in the previous column. For example, in a second pipetting operation of the protocol, an 8-channel pipetting device 600 is used to remove eight pipette tips 702. However, column 1 has insufficient pipette tips 702. Thus, pipetting device 600 moves over to column 2, thereby removing the column of pipette tips A2 to H2 in pipette tip rack 700.

Finally, in a third pipetting operation of the protocol, a multichannel pipetting device 600, configured to remove every other pipette tip 702 in column 3 of pipette tip rack 700 is used. In examples, the multichannel pipetting device 600 used to perform this third pipetting operation is an 8-channel pipettor, where every other tip mandrel 606 is independently lowered in the Z-direction relative to the other tip mandrels 606 of the 8-channel pipettor, so that only the lowered tip mandrels 606 engage a pipette tip 702 in pipette tip rack 700. FIG. 9B illustrates the status of the pipette tip rack 700 upon completion of this exemplary protocol.

As such, the pipette tip rack 700 of FIG. 9B is fragmented, as was accomplished in the illustrated example performing three different pipetting operations with different types of pipetting devices.

In additional examples of how pipette tip rack 700 can become fragmented, it may be possible that unused pipette tips 702 are left at the bottom edge or in middle portions of columns 1 through 12 due to the need for pipetting device 600 being able to access pipette tips 702 in rack 700 and then to be able to subsequently insert the loaded pipette tips 702 into labware on deck 220. For example, labware may be arranged on deck 220 such that pipette tips 702 loaded onto the bottom side of pipetting device 600 (relative to the orientation of FIG. 9A) may not be able to access the desired locations in reaction vessels 205 at location L13 due to the presence of other reaction vessels 205 on deck 220 at location L13. Thus, it may be advantageous for pipetting device 600 to fill the top portion of mandrels 606 with pipette tips 702.

Also, the pipetting operations of the loaded protocol may not require all of columns 1-12 to be used such that full pipette tip columns remain, as indicated by columns 4-12 in FIG. 9B.

Thus, at the end of finishing all the pipetting operations for a protocol, pipette tip rack 700 can be left with a scattering of pipette tips 702 within the matrix of the receptacles defined by columns 1-12 and rows A-H. Pipette tips 702 can be fragmented into chunks or individual pipette tips that leave too few pipette tips 702 to perform another protocol or that would require manifold 600 to make extra maneuvers to pick up unused pipette tips, thereby slowing performance times for the protocol. As such, it can be desirable to organize pipette tips 702, such as by defragmenting or reformatting the arrangement of pipette tips 702 in pipette tip rack 700.

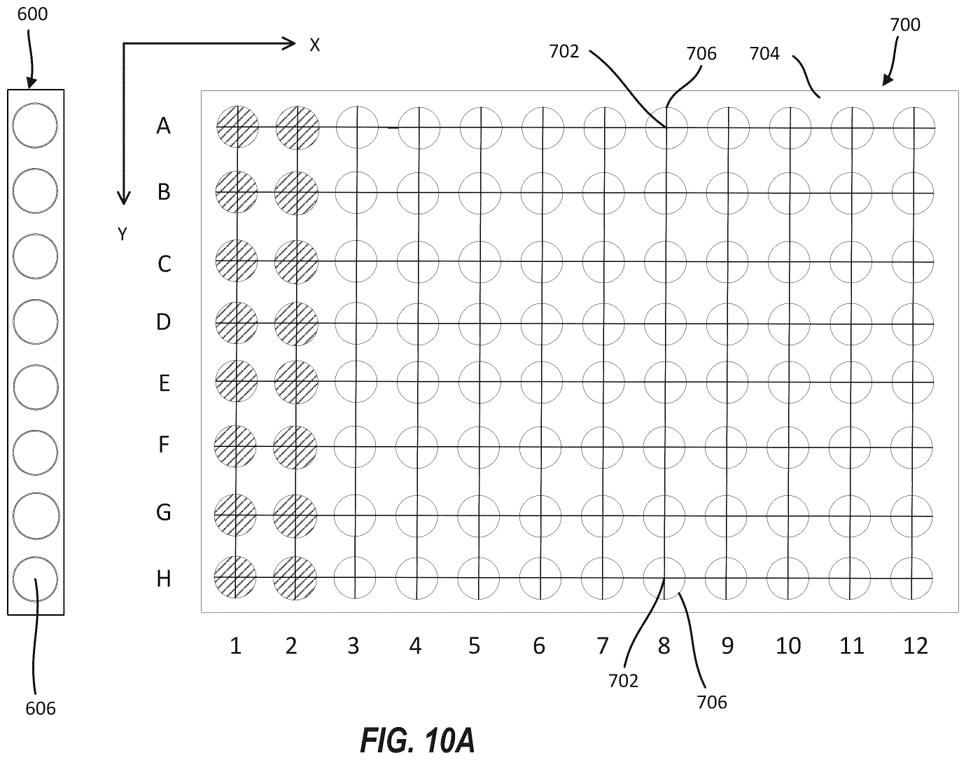

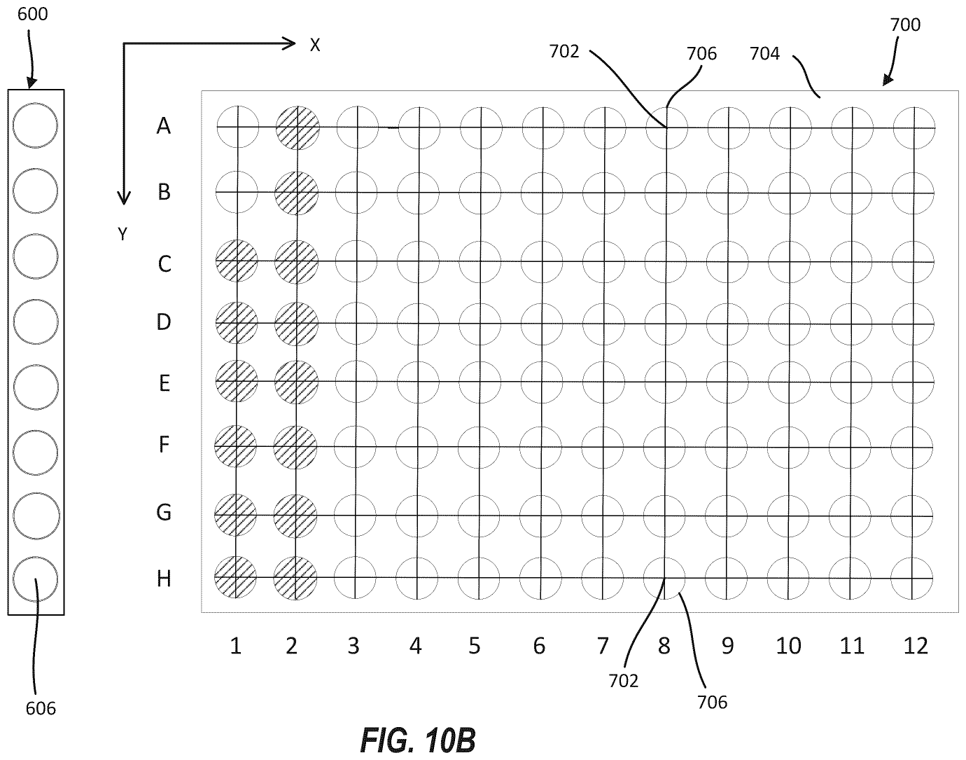

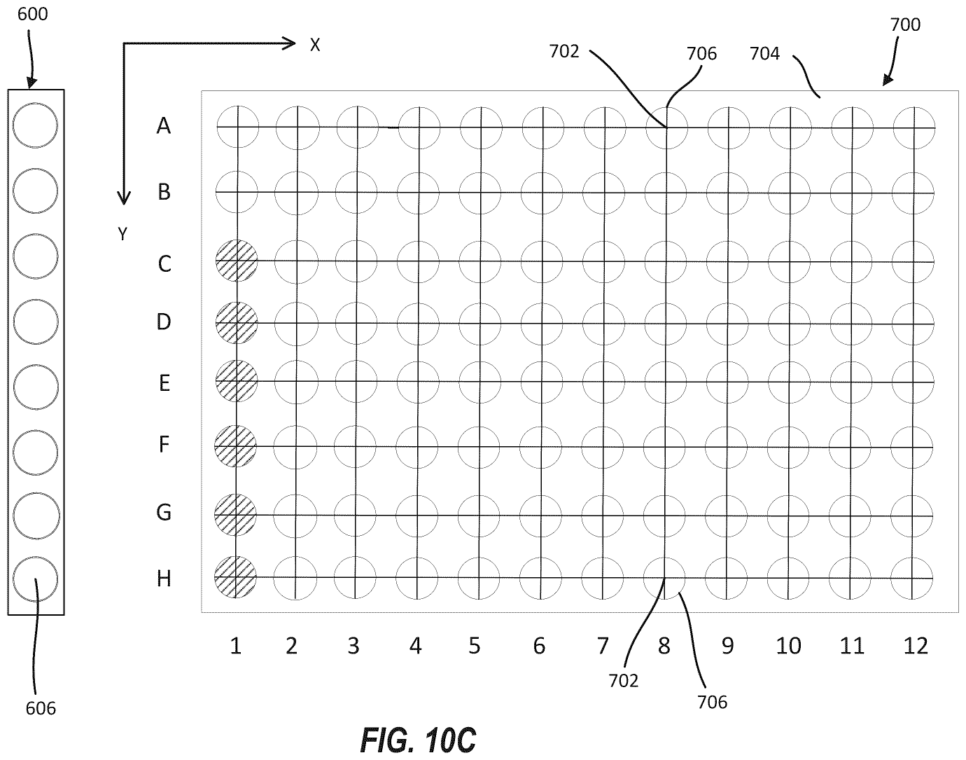

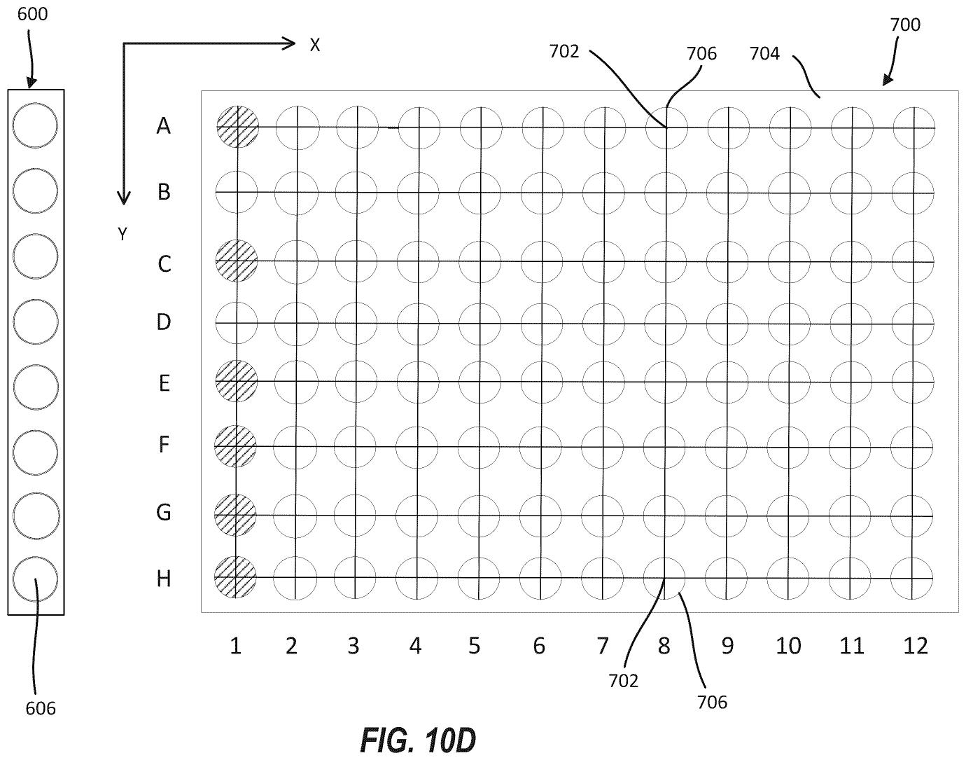

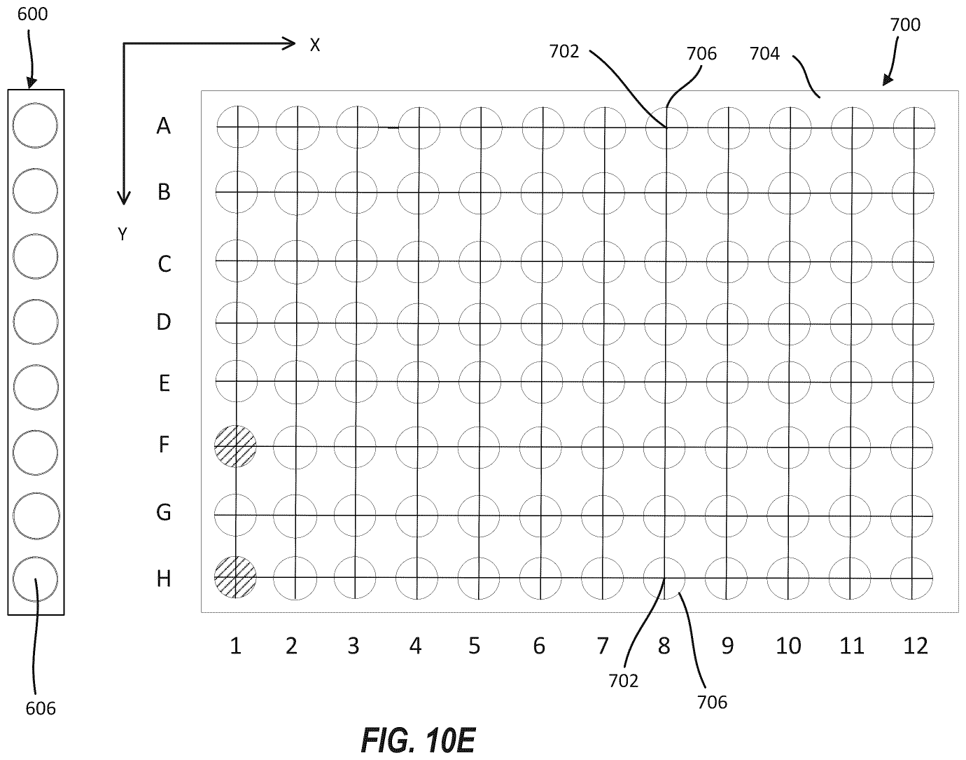

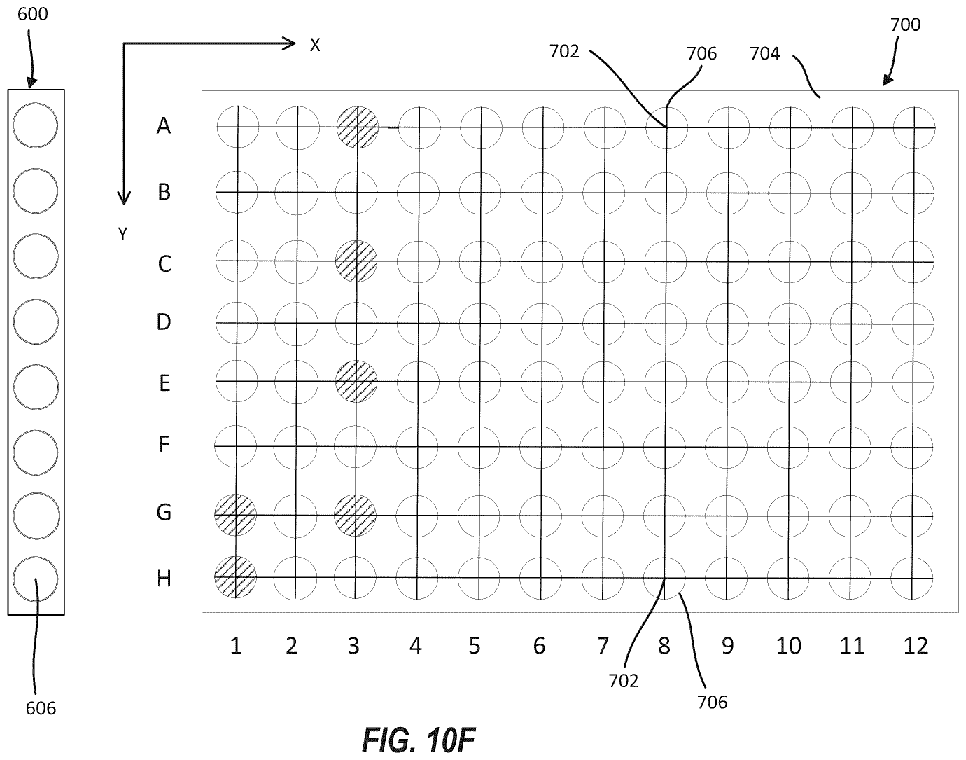

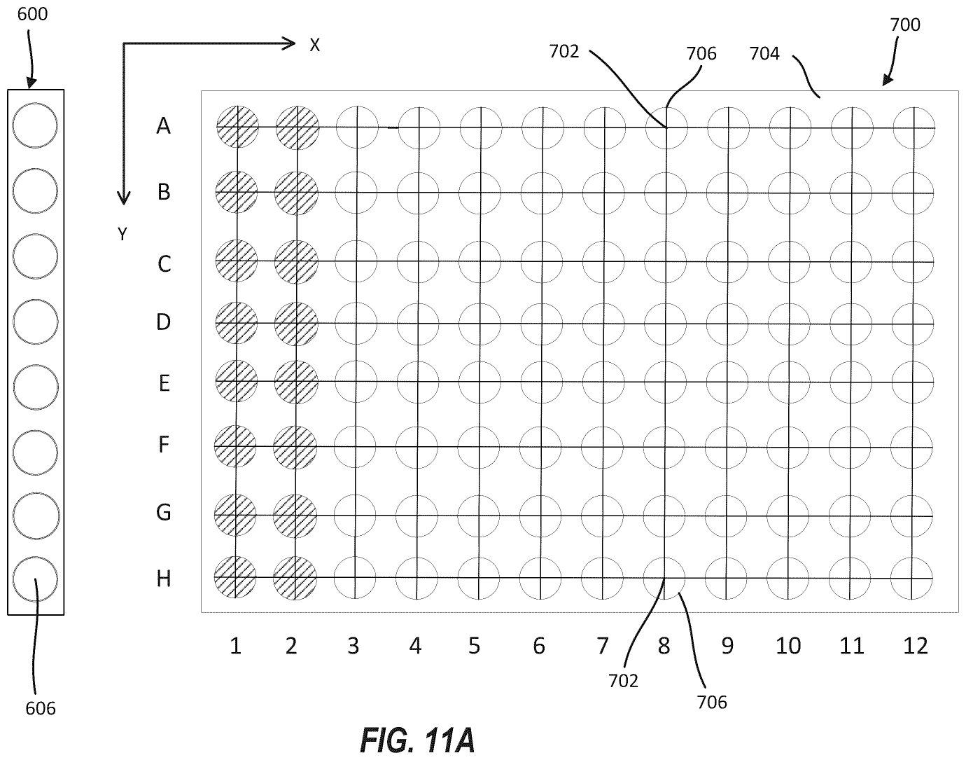

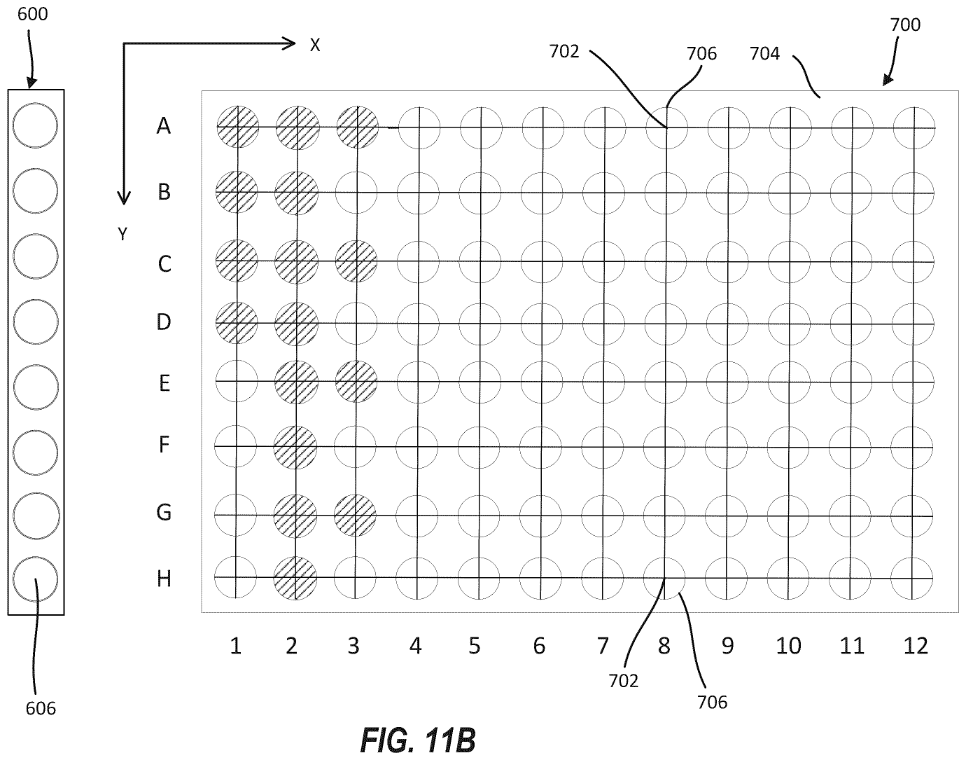

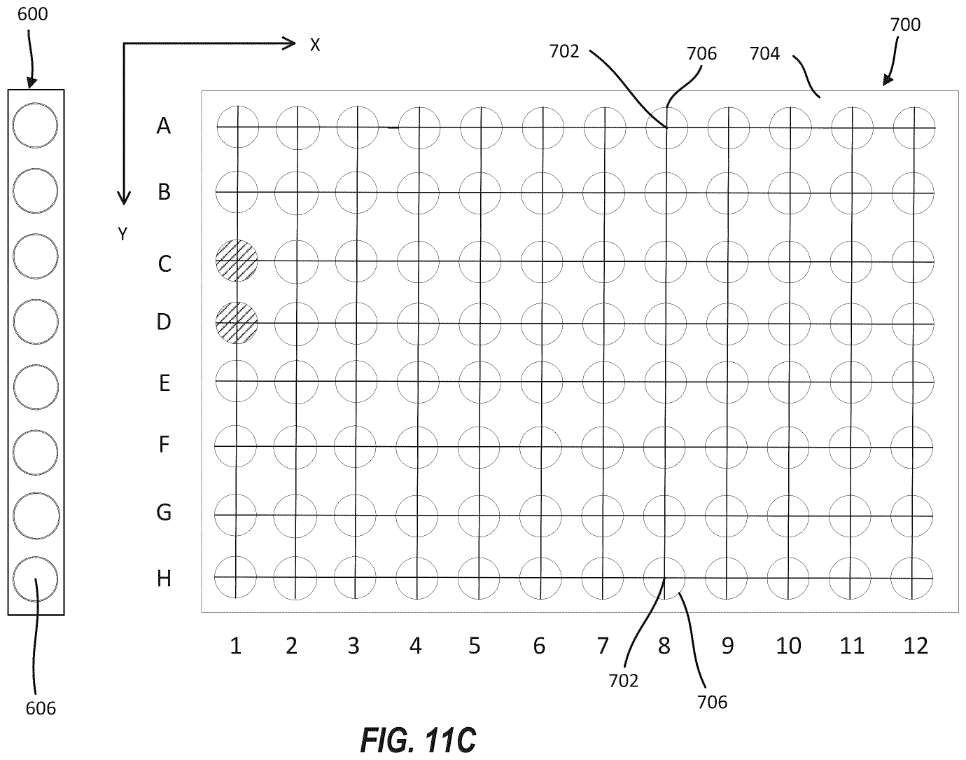

Reformatting can be performed after a protocol is executed, as discussed with reference to FIGS. 9C-9E. Reformatting can be performed during execution of a protocol, as discussed with reference to FIGS. 10A-10F. Reformatting can be performed before a protocol is executed, as discussed with reference to FIGS. 11A-11C. Additionally, reformatting steps can be performed during times when the robotics of system 100 or fluid handling system 200 are idle, in order to minimize extending the time required to complete the protocol. Likewise, the reformatting steps can be performed to not interrupt time-sensitive pipetting operations. That is, reformatting can be performed so as to not interrupt sequential or consecutive pipetting operations that should be, need to be, or are advantageously performed with minimal time delay between operations. “Time-sensitive” can be defined as a chemical reaction time that is shorter than a time it takes to perform the reformatting steps. Defragmenting can be performed at times that minimize or eliminate any increase in the run-time of the procedure, such as during a reaction incubation or any other time that the robotics are idle.

FIGS. 9C to 9E illustrate three examples of defragmenting and/or reformatting pipette tip rack 700 after performing the exemplary protocol.

In FIG. 9C, unused pipette tips from filled receptacles 706 in columns 11 and 12 of pipette tip rack 700, (pipette tips C11 to H12) are moved to fill the open receptacles 706 in columns 1 and 3 of the pipette tip rack 700. This provides a reformatted pipette tip rack 700 having a continuous string of filled receptacles 706 starting at A1, and the maximum number of completely-filled columns.

In FIG. 9D, the unused pipette tips in columns 1 and 3 of the pipette tip rack 700 are moved to fill open receptacles 706 in columns 2 and 3, to reformat the pipette tip rack 700 so that the pipette tip rack 700 has a continuous string of filled receptacles 706 from the end of the pipette tip rack at H12 backwards to tip G2. This provides a reformatted pipette tip rack 700 equivalent to that of FIG. 9C, after the pipette tip rack 700 is rotated 180 degrees and reloaded onto the deck 220 by a user before beginning this or another protocol.

In FIG. 9E, the unused pipette tips 702 in columns 1, 3, and 12 are moved to produce the pattern of filled receptacles 706 utilized by the exemplary protocol, as illustrated in FIG. 9B. In this way, the reformatted pipette tip rack 700 is optimally formatted for performing the exemplary protocol a second time.

FIGS. 10A to 10E illustrate an example of defragmenting and/or reformatting pipette tip rack 700 during the performance of the exemplary protocol of FIG. 9B.

FIG. 10A illustrates an example of pipette tip rack 700 before the exemplary protocol of FIG. 9B is initiated. In this example, the pipette tip rack 700 starts with 16 unused pipette tips 702 occupying columns 1 and 2 of the pipette tip rack 700. FIG. 10B illustrates the status of the pipette tip rack 700 after the first pipetting operation of the exemplary protocol has been performed, where the single-channel pipetting device 600 has removed the pipette tips 702 that were occupying receptacles 706 at locations A1 and A2. FIG. 10C illustrates the status of the pipette tip rack 700 after performing the second pipetting operation using the 8-channel pipetting device 600 to remove the pipette tips 702 that were occupying column 2 of the pipette tip rack 700. At this stage, there is no partial column of unused pipette tips 702 in pipette tip rack 700 accessible to the multichannel pipetting device 600 used for the third pipetting operation of this protocol, since this multichannel pipetting device 600 is configured to remove every other pipette tip 702 in a column of the pipette tip rack 700. Accordingly, the pipetting device 600 reformats the pipette tip rack 700 by moving the unused pipette tip 702 at location DI to the open receptacle at location A1 of the pipette tip rack 700. Thus, after this reformatting, the third pipetting operation of this exemplary protocol can be performed, resulting in the removal the of pipette tips 702 at locations A1, C1, E1, and G1 of pipette tip rack 700. FIG. 10E illustrates the status of the pipette tip rack 700 after completion of the exemplary protocol.

In another example, the pipette tip rack 700 of FIG. 10C can be reformatted after performing the second pipetting operation of the exemplary protocol by moving 4 of the unused pipette tips 702 in column 1 of the pipette tip rack 700 to the alternating positions A3, C3, E3, and G3 in column 3 of the pipette tip rack 700, as illustrated in FIG. 10F. In this way, the third pipetting operation of the exemplary protocol can be performed as originally illustrated in FIG. 9B (i.e. using column 3 of the pipetting tip rack 700). In this example, however, because the pipette tip rack 700 has been reformatted to have every-other receptacle 706 in column 3 of the pipette tip rack 700 empty, the third pipetting operation of the exemplary protocol can be performed with a typical 8-channel pipettor, (i.e. where each tip mandrel 606 remains in a fixed Z-position relative to the other tip mandrels 606), thereby eliminating the need for a multichannel pipetting device 600 having tip mandrels 606 that are independently movable in the Z-direction.

The methods of reformatting or defragmenting a pipette tip rack 700 performed during the performance of a protocol, as described herein, can be combined with any suitable method of reformatting or defragmenting the pipette tip rack 700 performed after the performance of the protocol, as also described herein.

FIGS. 11A to 11C illustrate an example of defragmenting and/or reformatting the pipette tip rack 700 before performing the exemplary protocol of FIG. 9B. In this example, the pipette tip rack 700 starts with sixteen unused pipette tips 702 occupying columns 1 and 2 of the pipette tip rack 700, as illustrated in FIG. 11A. Before beginning the protocol, pipetting device 600 moves the 4 unused pipette tips 702 from locations E1 to H1 of the pipette tip rack 700 to locations A3, C3, E3, and G3, as illustrated in FIG. 11B. Following this reformatting, the exemplary protocol described in relation to FIG. 9B is performed, including the use of a multichannel pipetting device 600 configured to remove every other pipette tip 702 in column 3 of pipette tip rack 700 in the third pipetting operation of the protocol, resulting in a status of the pipette tip rack 700 as illustrated in FIG. 11C after the completion of the protocol. In another example, following the reformatting illustrated in FIG. 11B, the exemplary protocol is performed, except that a typical 8-channel pipettor is used to perform the third pipetting operation, instead of a multichannel pipetting device 600 that is specifically configured to remove every other pipette tip 702 in a column of the pipette tip rack 700. More generally, reformatting methods of the present disclosure can be used to attach pipette tips 702 to any number and combination of tip mandrels 606 of a multichannel pipetting device 600, thereby eliminating the need for a separate pipetting device 600 having tip mandrels 606 that are independently movable in the Z- (or X- or Y) direction.

The methods described herein of reformatting and/or defragmenting a pipette tip rack 700, either before, during, and/or after performing a protocol, may be combined in any suitable manner or combination.

In some examples, the pipette tip rack 700 is used as a source of unused pipette tips 702 for a selected protocol. In some examples, the pipette tip rack 700 is used to receive and segregate used pipette tips 702 from unused pipette tips 702. In some examples, the reformatting and/or defragmenting methods described herein can be separately used on a pipette tip rack 700 that is used as a source of unused pipette tips 702 and on a pipette tip rack 700 that is used to receive used pipette tips 702, in any suitable combination.

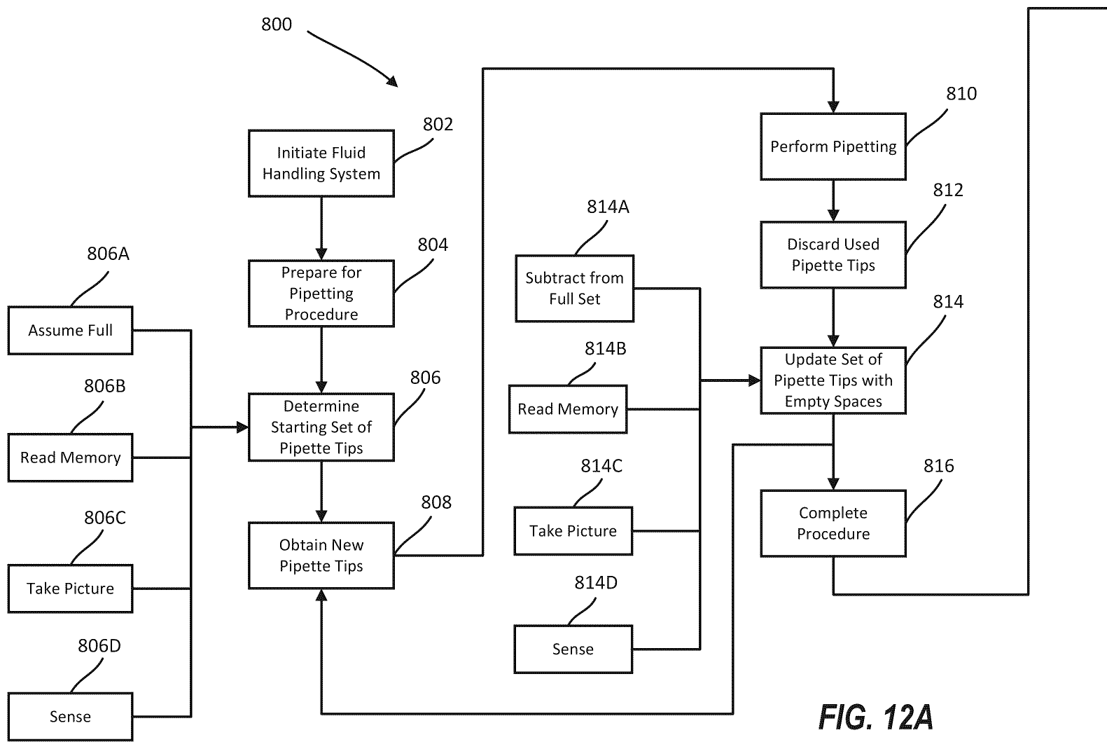

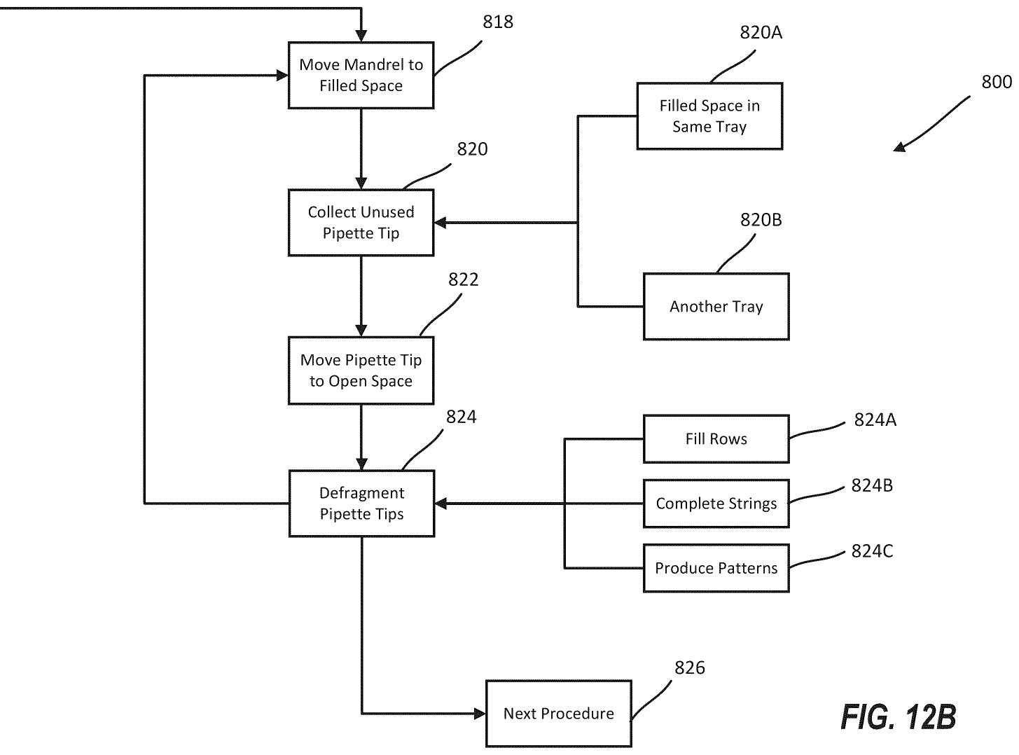

FIGS. 12A and 12B illustrate line diagram 800 showing steps and operations for automatically performing pipette tip organization of pipette tips 702 in pipette tip rack 700 of FIG. 9A. Line diagram 800 can describes examples of reformatting and defragmentation explained above. The procedures described with reference to line diagram 800 can be executed using processing system 100 and robotic fluid handling system 200 of FIGS. 1-7, such as by being controlled by control computer 108 (FIG. 1) with instructions stored in computer readable medium 108B.

Step 802 can comprise initiating fluid handling system 200 (FIG. 2). An operator can power-on fluid handling system 200 or otherwise prepare fluid handling system 200 for the performance of a protocol or another operation. An operator can interface with input device 108D (FIG. 1) or controller 214 (FIG. 2) to initiate fluid handling system 200.

Step 804 can comprise preparing fluid handling system 200 for performing a procedure involving pipetting. Thus, a protocol can be programmed into input device 108D (FIG. 1) or controller 214 (FIG. 2). The protocol can include one or more sub-steps including pipetting operations with pipetting device 600 where a different set of pipette tips 702 is utilized in each pipetting operations, thereby resulting in pipetting device 600 making multiple trips to tip rack 700 (FIG. 8) to obtain the requisite number of pipette tips 702 to be used in each pipetting operation. Thus, tip mandrels 606 can be repeatedly load and unload pipette tips 702 in different combinations to perform the pipetting operations.

Step 806 can comprise determining the starting set of pipette tips 702 loaded into fluid handling system 200. Control computer 108 can determine the starting set of pipetting tips 702 in a plurality of ways, as described with reference to steps 806A-806D. Control computer 108 can do one, a plurality of, or all of steps 806A-806D to determine the starting set. The starting set of pipette tips 702 can be determined in different ways for redundancy to help ensure that the correct number of pipette tips 702 is properly determined.

Step 806A can comprise processing system 100 assuming that pipette tip rack 700 loaded onto deck 220 is full. In examples, processing system 100 can recognize the presence of pipette tip rack 700 of deck 220 using imaging device 206 and then assign an unused pipette tip 702 to each receptacle 706 in pipette tip rack 700. In examples, processing system 100 can read the type of pipette tip rack 700 used in a protocol stored in computer readable medium 108B, determine from computer readable medium 108B the number and location of receptacles 706 for pipette tips 702 in the pipette tip rack 700, and then assign an unused pipette tip 702 to each receptacle 706 in the pipette tip rack 700.

Step 806B can comprise processing system 100 reading the number and locations of pipette tips 702 loaded onto deck 220 from a protocol stored in computer readable medium 108B. For example, the protocol stored in computer readable medium 108B can directly recite the number and locations of receptacles 706 for pipette tip rack 700 and further recite which of receptacles 706 include an unused pipette tip 702.

Step 806C can comprise using imaging device 206 (FIGS. 2 and 3) to view pipette tips 702 in pipette tip rack 700 so that processing system 100 can utilize image recognition software, algorithms, or procedures to count the number of pipette tips 702 in rack 700. For example, digital images of deck 220 can be analyzed for shapes or patterns that match stored shapes and patterns in computer readable medium 108B of pipette tips 702. Thus, the number of shapes or patterns in the digital image can be counted to determine the starting set of pipette tips 702.

Step 806D can comprise sensing the number of pipette tips 702 in pipette tip rack 700. Processing system 100 can move pipetting device 600 to the location of pipette tip rack 700 to contact one of tip mandrels 606 with each of receptacles 706 in pipette tip rack 700. Where tip mandrels 606 obtain a capacitance reading in the expected location of a pipette tip rack 700, computer readable medium 108B can be updated to record the location of a pipette tip 702. Where tip mandrels 606 do not obtain a capacitance reading in the expected location of a pipette tip rack 700, computer readable medium 108B can be updated to record the absence of a pipette tip 702. In additional examples, processing system 100 can recognize the difference in Z height for the reading of a capacitance signal to distinguish between a higher Z location where a pipette tip 702 is located or a lower Z location where contact with an empty receptacle 706 is made. Furthermore, processing system 100 can recognize the difference in Z height via use of a pressure sensor.

Step 808 can comprise obtaining a new pipette tip 702 using pipetting device 600. Processing system 100 can begin to perform the first pipetting operation of the protocol from step 804. Pipetting device 600 can be moved to the location of pipette tip rack 700 to obtain pipette tips 702. Pipetting device 600 can be moved downward in the Z direction to engage tip mandrels 606 with collars 710 of a select number of pipette tips 702 to be loaded onto pipetting device 600 to perform pipetting procedures.

Step 810 can comprise performing a pipetting operation using the new pipette tips 702 loaded onto tip mandrel 606. The pipette tips 702 gathered at step 808 can be moved over one or more items of labware loaded onto deck 220 (FIG. 4). Fluid or liquid can be drawn out of those items of labware with the pipette tips 702 loaded onto tip mandrels 606 by plunger 610 moving upward, and then transported to another item of labware where plunger 610 can be pushed downward to dispense the fluid or liquid into the second item of labware. As a result of such dispensing process, the pipette tips 702 loaded onto tip mandrels 606 can become dirty, thereby making it desirable to unload such pipette tips 702 in favor of unused, clean pipette tips 702 for the next pipetting operation to avoid contamination, etc.

Step 812 can comprise discarding the dirty pipette tip 702 used in step 810. Pipetting device 600 can be moved from the second item of labware in step 810 to waste storage area L16 for bin 224 (FIG. 4). Tip mandrels 606 can eject the dirty pipette tips 702 into bin 224 by moving plungers 610 further downward to push the used pipette tips 702 of tip mandrels 606.

Step 814 can comprise updating the starting set of pipette tips 702 of step 806 to subtract the used pipette tips. The starting set of pipette tips can be updated in a plurality of ways described with reference to steps 814A-814D. Control computer 108 can do one, a plurality of, or all of steps 814A-814D to determine the updated set. The updated set of pipette tips 702 can be determined in different ways for redundancy to help ensure that the correct number of pipette tips 702 is properly determined.

Step 814A can comprise subtracting the number of pipette tips 702 used and discarded at steps 810 and 812 from the starting or full set of pipette tips, such as provided by steps 806A-806D. The number of pipette tips 702 used at step 808 can be read from the protocol stored in computer readable medium 108B. The protocol can include a list of the number of pipette tips 702 used in each sub-step or pipetting operation of the protocol. Thus, control computer 108 can maintain a running ledger of pipette tips by continuously subtracting the number of used pipette tips from the starting total. Computer readable medium 108B can be updated with the remaining numbers and locations of clean and unused pipette tips 702.

Step 814B can comprise reading memory of fluid handling system 200 to determine the number of pipette tips 702 that remain after the particular pipetting procedures have been performed at step 810. For example, control computer 108 can consult the protocol loaded at step 804 to determine how many pipette tips 702, and their locations should remain after steps 810 and 812 are performed. The protocol can maintain a running ledger of pipette tips for the protocol after each sub-step or pipetting operation of the protocol. Computer readable medium 108B can be updated with the remaining numbers and locations of clean and unused pipette tips 702.

Step 814C can comprise using imaging device 206 (FIG. 2) to take a digital picture of pipette tip rack 700 where pipette tips 702 of step 808 were obtained. Control computer 108 can use image recognition software algorithms stored in computer readable medium 108B to recognize which of receptacles 706 in pipette tip rack 700 are occupied, such as those described with reference to step 806C. Computer readable medium 108B can be updated with the remaining numbers and locations of clean and unused pipette tips 702.

Step 814D can comprise using tip mandrel 606 to sense pipette tips in pipette tip rack 700. As described with reference to step 806D, pipetting device 600 can be moved around pipette tip rack 700 to engage tip mandrels 606 with pipette tips 702 and receptacles 706 to determine which receptacles 706 are occupied. Computer readable medium 108B can be updated with the remaining numbers and locations of clean and unused pipette tips 702.

After step 814, steps 808-814 can be repeated as necessary to complete the protocol loaded at step 804 until all the requisite pipetting operations have been performed.

Step 816 can comprise completing the protocol loaded at step 804 and all the pipetting procedures called for therein. Processing system 100 can be changed over to a completed state where a user can operate controller 214 and cover panel 210 to obtain the desired result of the protocol, e.g., a library construction. However, before or after operation of processing system 100 is turned over to user control, control computer 108 can be used to perform the pipette tip organizing procedures described herein. Such pipette tip organizing procedures can be performed automatically by control computer 108 without user intervention. However, in examples, a user can load a new, full or partially filled pipette tip rack 700 into processing system 100 to make new pipette tips available for the organizing procedures. In any case, fluid handling system 200 can be operated to look for the locations of unused pipette tips on deck 220, such as by using image recognition, performing sensing with mandrels 606, or consulting information stored in computer readable medium 108B.

Step 818 can comprise moving pipetting device 600 to a space at pipette tip rack 700 where an unused pipette tip 702 is located from a location determined at step 816.

Step 820 can comprise moving pipetting device 600 to collect an unused pipette tip 702 by engaging tip mandrel 606 with the pipette tip 702. The new or clean pipette tip 702 can be collected from an occupied receptacle 706 in the same pipette tip rack 700 at step 820A, or can be collected from an occupied receptacle 706 in a different pipette tip rack 700 than was used to perform steps 806-816 at step 820B. In examples, an additional pipette tip rack 700, partially or fully loaded with pipette tips 702, can be positioned onto deck 220 at step 802 such that performance of the protocol is not interrupted. In additional examples, an additional pipette tip rack 700, partially or fully loaded with pipette tips 702, can be positioned onto deck 220 after step 816.

Step 822 can comprise moving pipetting device 600 to a space at pipette tip rack 700 where a pipette tip is not located. Pipetting device 600 can then use mandrel 606 to eject the pipette tip 702 collected at 820 into the unoccupied receptacle 706.

Step 824 can comprise defragmenting the pipette tips 702 of the pipette tip rack 700 used in steps 806-816 by repeating steps 818-822. Step 824A can comprise defragmenting the pipette tips 702 by filling rows or columns of the pipette tip rack 700 used in steps 806-816. Step 824B can comprise defragmenting the pipette tips 702 by completing strings of pipette tips 702. Step 824C can comprise defragmenting the pipette tips 702 by producing patterns of pipette tips 702, such as patterns of pipette tips accessed by the pipetting device according to a selected protocol. Other defragmenting and reformatting procedures can additionally be performed.

Step 826 can comprise finishing operations of processing system 100. Thus, the defragmentation process of steps 818-824 can be completed. All of the pipetting operations of steps 808-814 can be completed, and the protocol loaded at step 804 can be completed. Thus, processing system 100 can be returned to user control, such as to obtain the results of the just completed protocol and to prepare processing system 100 for a subsequent protocol without having to manually reorganize, reformat or defragment pipette tips 702.

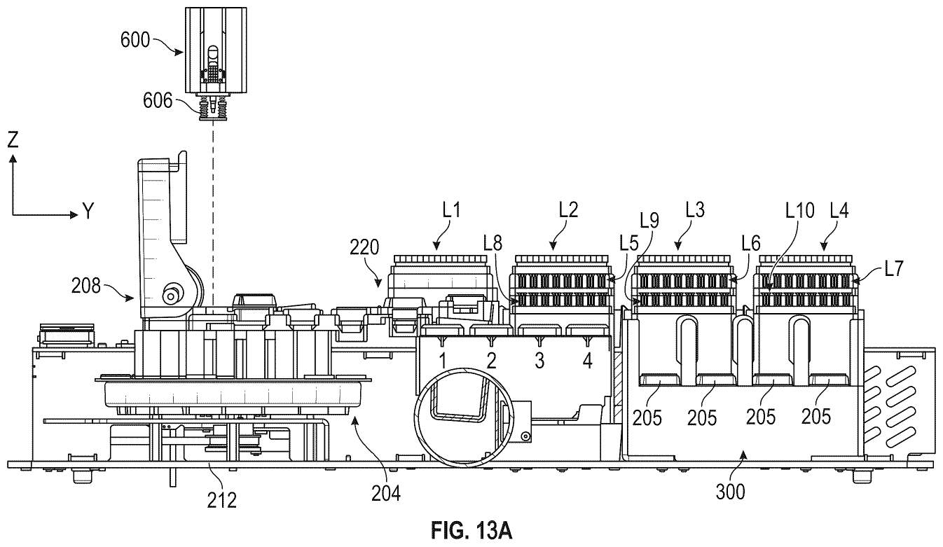

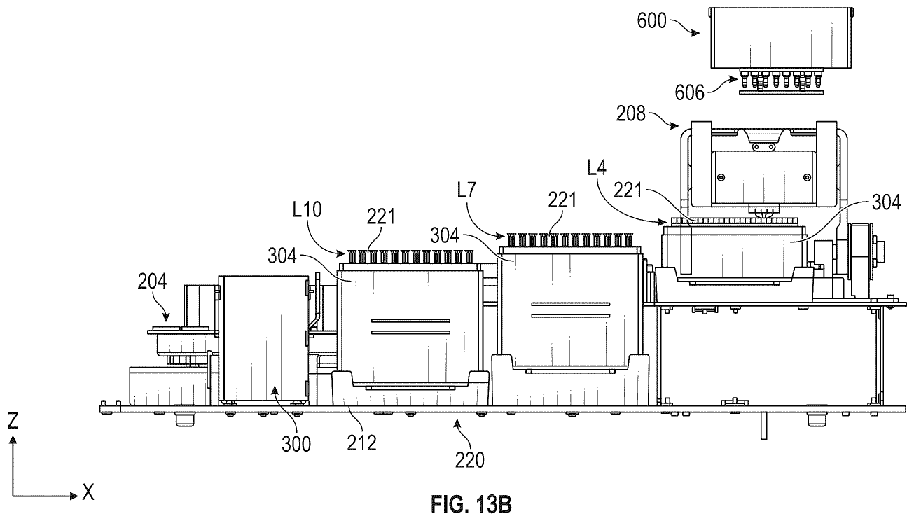

FIG. 13A is side view of deck 220 of FIG. 4 taken along the Y-direction to show locations L2-L10 for tip racks 221 arranged in a stadium configuration to facilitate access by pipetting device 600. FIG. 13B is a side view of deck 220 of FIG. 4 taken along the X-direction to show locations L4, L7 and L10 for tip racks 221 arranged in tiers for the stadium configuration to facilitate access by pipetting device 600. FIGS. 13A and 13B are discussed concurrently Deck 220 can be positioned on platform 212. Deck 220 can provide a raised area to provide access of pipetting device 600 to various items, such as carousel 204, thermal cycler system 208, bulk reaction vessel holder 300, as well as other items and devices described herein. Reaction vessels 205 can be located in bulk reaction vessel holder 300. Milli-tip racks 221 can be loaded into receptacles 304.

As can be seen in FIG. 13B, locations L10, L7 and L4 can be arranged in tiers where location L10 is closest to platform 212, location L4 is furthest from platform 212 and location L7 is positioned between locations L10 and L4 in the Z direction. As can be seen in FIG. 11A, locations L2, L5 and L8 and L3, L6 and L9, respectively, can additionally be grouped in such a tiered arrangement. Furthermore, in other examples, all of locations L1 through L10 can be provided at the same distance from platform 212 in the Z direction. However, tiering of locations on platform 212 can facilitate access to more receptacles in tip racks 221 by pipetting device 600. As explained above, it can be difficult for each tip mandrel 606 of pipetting device 600 to access every pipette tip located within a tip rack 221 due to the orientation of the string of tip mandrels 606 (see FIGS. 9A and 13B) and the presence of an adjacent tip rack 221 to tip rack 221 that is desired to be accessed. For example, it can be difficult, if not impossible, for tip mandrels 606 on the far right-hand side of manifold 600 (relative to the orientation of FIG. 13B) in the X direction to pick up pipette tips at the far left-hand side of location L4 due interference between tip mandrels 606 on the far left-hand side of pipetting device 600 interfering with pipette tips at the far right-hand side of location L7. As such, tiering of locations L10, L7 and L4, as shown in FIG. 13B can alleviate this problem such that the pipette tips at the far right-hand side of location L7 are positioned below tip mandrels 606 on the far left-hand side of pipetting device 600.

The reformatting and defragmenting methods of the present disclosure are not limited to protocols involving pipetting operations. The defragmenting and reformatting methods, operations and procedures described herein can be used more generally in dedicated reformatting and defragmenting protocols. In examples, the reformatting and defragmenting protocols of the present disclosure can recognize, such as by using a camera or capacitance or pressure sensing, the types and number of tip boxes loaded onto a deck, the number and position of tips in each box, can recognize and handle tip boxes with or without lids, and can automatically reformat or defragment to produce full and partial boxes more optimized for future use. In examples, the reformatting and defragmenting protocols can be run by other machines than liquid or fluid handling systems described herein.

### EXAMPLES

Example 1 is a method for automatically defragmenting pipette tips in a tip tray during performance of a procedure defined by a protocol stored in memory of a fluid handling system, the method comprising: determining locations of open receptacles in the tip tray where pipette tips are absent: determining locations of filled receptacles in the tip tray where pipette tips are present; and using the fluid handling system to move pipette tips from filled receptacles to open receptacles to complete strings of filled receptacles in the tip tray.

In Example 2, the subject matter of Example 1 optionally includes removing pipette tips from filled receptacles in the tip tray using one or more tip mandrels of a pipetting device of the fluid handling system: performing a pipetting operation with the pipetting device using removed pipette tips, the pipetting operation performed according to the protocol; and discarding the removed pipette tips after performing the pipetting operation to produce the open receptacles in the tip tray.

In Example 3, the subject matter of Example 2 optionally includes wherein determining the locations of open and filled receptacles in the tip tray comprises: viewing the locations of open and filled receptacles with a camera: recognizing open and filled receptacles of the tip tray in images of the tip tray; and mapping the open and filled receptacles to a tip tray map stored in memory of the fluid handling system.

In Example 4, the subject matter of any one or more of Examples 2-3 optionally include wherein determining the locations of open and filled receptacles in the tip tray comprises: obtaining a tip tray map from the protocol stored in memory of the fluid handling system indicating locations of filled receptacles in the tip tray; and subtracting pipette tips from the filled receptacles to produce open receptacles in the tip tray map as pipette tips are used during the pipetting operation.

In Example 5, the subject matter of Example 4 optionally includes wherein the tip tray map is defaulted to a filled capacity of the tip tray at the beginning of the procedure.

In Example 6, the subject matter of any one or more of Examples 4-5 optionally include wherein the tip tray map is set according to an initial status indicated in the protocol.

In Example 7, the subject matter of any one or more of Examples 2-6 optionally include wherein determining the locations of open and filled receptacles in the tip tray comprises sensing for presence of pipette tips at each receptacle in the tip tray.

In Example 8, the subject matter of Example 7 optionally includes wherein the presence of pipette tips at each receptacle is determined using a capacitive sensing system associated with the fluid handling system.

In Example 9, the subject matter of Example 8 optionally includes wherein the presence of pipette tips at each receptacle is determined using the capacitive sensing system associated with the fluid handling system at the beginning and end of the procedure.

In Example 10, the subject matter of any one or more of Examples 2-9 optionally include wherein determining the locations of open and filled receptacles in the tip tray is performed at the beginning of the procedure.

In Example 11, the subject matter of any one or more of Examples 2-10 optionally include wherein determining the locations of open and filled receptacles in the tip tray is performed at the end of the procedure.

In Example 12, the subject matter of any one or more of Examples 2-11 optionally include wherein determining the locations of open and filled receptacles in the tip tray is performed during the procedure.

In Example 13, the subject matter of Example 12 optionally includes performing consecutive time-sensitive pipetting operations of the procedure before determining the locations of open and filled receptacles in the tip tray.

In Example 14, the subject matter of any one or more of Examples 12-13 optionally include determining that a number of consecutive filled-receptacles in the tip tray is insufficient to perform a step of the pipetting operation; and moving pipette tips from filled receptacles to open receptacles in the tip tray to provide the number of consecutive filled-receptacles sufficient to perform said step of the pipetting operation before performing said step.

In Example 15, the subject matter of any one or more of Examples 1-14 optionally include wherein moving pipette tips from filled receptacles to open receptacles to complete strings of filled receptacles in the tip tray comprises: moving pipette tips to less obstructed locations in the tip tray.

In Example 16, the subject matter of any one or more of Examples 1-15 optionally include wherein moving pipette tips from filled receptacles to open receptacles to complete strings of filled receptacles in the tip tray comprises: moving all the pipette tips in a partial row or column in the tip tray to consecutive open receptacles of another row or column in the tip tray.

In Example 17, the subject matter of any one or more of Examples 1-16 optionally include wherein moving pipette tips from filled receptacles to open receptacles to complete strings of filled receptacles in the tip tray comprises: completely filling a partial row or column of receptacles in the tip tray with pipette tips from other rows or columns in the tip tray.

Example 18 is a method for automatically defragmenting pipette tips in a tip tray during performance of a procedure defined by a protocol stored in memory of a fluid handling system, the method comprising: determining locations of open receptacles in the tip tray where pipette tips are absent: determining locations of filled receptacles in the tip tray where pipette tips are present; and using the fluid handling system to move pipette tips from filled receptacles to open receptacles to producing patterns of filled receptacles in rows of the tip tray according to usage of tips as defined in the protocol.

Example 19 is a method for automatically defragmenting pipette tips in a first tip tray during performance of a procedure defined by a protocol stored in memory of a fluid handling system, the method comprising: determining locations of open receptacles in the first tip tray where pipette tips are absent: determining locations of filled receptacles in the first tip tray where pipette tips are present; and using the fluid handling system to move pipette tips from filled receptacles of a second tip tray to open receptacles to complete strings of filled receptacles in the first tip tray.

In Example 20, the subject matter of Example 19 optionally includes wherein moving pipette tips from filled receptacles to open receptacles to complete strings of filled receptacles in the second tip tray comprises: moving pipette tips to different tiers of a platform of the fluid handling system.

### VARIOUS NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method for automatically defragmenting pipette tips in a tip tray during performance of a procedure defined by a protocol stored in memory of a fluid handling system, the method comprising:
determining locations of open receptacles in the tip tray where pipette tips are absent;
determining locations of filled receptacles in the tip tray where pipette tips are present; and
using the fluid handling system to move pipette tips from filled receptacles to open receptacles to complete strings of filled receptacles in the tip tray.

2. The method of claim 1, further comprising:
removing pipette tips from filled receptacles in the tip tray using one or more tip mandrels of a pipetting device of the fluid handling system;
performing a pipetting operation with the pipetting device using removed pipette tips, the pipetting operation performed according to the protocol; and
discarding the removed pipette tips after performing the pipetting operation to produce the open receptacles in the tip tray.

3. The method of claim 2, wherein determining the locations of open and filled receptacles in the tip tray comprises:
viewing the locations of open and filled receptacles with a camera;
recognizing open and filled receptacles of the tip tray in images of the tip tray; and
mapping the open and filled receptacles to a tip tray map stored in memory of the fluid handling system.

4. The method of claim 2, wherein determining the locations of open and filled receptacles in the tip tray comprises:
obtaining a tip tray map from the protocol stored in memory of the fluid handling system indicating locations of filled receptacles in the tip tray; and
subtracting pipette tips from the filled receptacles to produce open receptacles in the tip tray map as pipette tips are used during the pipetting operation.

5. The method of claim 4, wherein the tip tray map is defaulted to a filled capacity of the tip tray at the beginning of the procedure.

6. The method of claim 4, wherein the tip tray map is set according to an initial status indicated in the protocol.

7. The method of claim 2, wherein determining the locations of open and filled receptacles in the tip tray comprises sensing for presence of pipette tips at each receptacle in the tip tray.

8. The method of claim 7, wherein the presence of pipette tips at each receptacle is determined using a capacitive sensing system associated with the fluid handling system.

9. The method of claim 8, wherein the presence of pipette tips at each receptacle is determined using the capacitive sensing system associated with the fluid handling system at the beginning and end of the procedure.

10. The method of claim 2, wherein determining the locations of open and filled receptacles in the tip tray is performed at the beginning of the procedure.

11. The method of claim 2, wherein determining the locations of open and filled receptacles in the tip tray is performed at the end of the procedure.

12. The method of claim 2, wherein determining the locations of open and filled receptacles in the tip tray is performed during the procedure.

13. The method of claim 12, further comprising performing consecutive time-sensitive pipetting operations of the procedure before determining the locations of open and filled receptacles in the tip tray.

14. The method of claim 12, further comprising:
determining that a number of consecutive filled-receptacles in the tip tray is insufficient to perform a step of the pipetting operation; and
moving pipette tips from filled receptacles to open receptacles in the tip tray to provide the number of consecutive filled-receptacles sufficient to perform said step of the pipetting operation before performing said step.

15. The method of claim 1, wherein moving pipette tips from filled receptacles to open receptacles to complete strings of filled receptacles in the tip tray comprises:
moving pipette tips to less obstructed locations in the tip tray.

16. The method of claim 1, wherein moving pipette tips from filled receptacles to open receptacles to complete strings of filled receptacles in the tip tray comprises:
moving all the pipette tips in a partial row or column in the tip tray to consecutive open receptacles of another row or column in the tip tray.

17. The method of claim 1, wherein moving pipette tips from filled receptacles to open receptacles to complete strings of filled receptacles in the tip tray comprises:
completely filling a partial row or column of receptacles in the tip tray with pipette tips from other rows or columns in the tip tray.

18. A method for automatically defragmenting pipette tips in a tip tray during performance of a procedure defined by a protocol stored in memory of a fluid handling system, the method comprising:
determining locations of open receptacles in the tip tray where pipette tips are absent;
determining locations of filled receptacles in the tip tray where pipette tips are present; and
using the fluid handling system to move pipette tips from filled receptacles to open receptacles to producing patterns of filled receptacles in rows of the tip tray according to usage of tips as defined in the protocol.

19. A method for automatically defragmenting pipette tips in a first tip tray during performance of a procedure defined by a protocol stored in memory of a fluid handling system, the method comprising:
determining locations of open receptacles in the first tip tray where pipette tips are absent;
determining locations of filled receptacles in the first tip tray where pipette tips are present; and
using the fluid handling system to move pipette tips from filled receptacles of a second tip tray to open receptacles to complete strings of filled receptacles in the first tip tray.

20. The method of claim 19, wherein moving pipette tips from filled receptacles to open receptacles to complete strings of filled receptacles in the second tip tray comprises:
moving pipette tips to different tiers of a platform of the fluid handling system.
